(19) United States
(12) Patent Application Publication
(10) Pub. No.: US 2014/0111534 A1
(43) Pub. Date: Apr. 24, 2014

(54) Media-Editing Application for Generating and Editing Shadows

(71) Applicant: APPLE INC., Cupertino, CA (US)

(72) Inventors: Gregory E. Niles, Culver City, CA (US); Mitchell S. Middler, Hermosa Beach, CA (US); Dylan F. Moore, Santa Monica, CA (US); Linda L. Dong, San Francisco, CA (US); Michael P. Stern, San Francisco, CA (US)

(73) Assignee: APPLE INC., Cupertino, CA (US)

(21) Appl. No.: 13/657,842

(22) Filed: Oct. 22, 2012

(51) Int. Cl. G09G 5/02

(52) U.S. Cl. 345/589

(57) ABSTRACT

Some embodiments provide a media editing application for generating and editing shadows. The media editing application provides a set of editing tools for creating a composite presentation from first and second media clips, and a preview display area for displaying a preview of the composite presentation. In some embodiments, the media editing application provides a shadow generation tool for generating a shadow for the second media clip and displaying the shadow in the preview display area. The shadow is composited with the first and second media clips to create the composite presentation. The shadow projection tool of some embodiments includes a set of on-image controls for display in the preview display area near the second media clip. The set of on-image controls can be moved on the preview display to modify a set of attributes of the shadow.

### BACKGROUND

Digital graphic design, image editing, and video editing applications (i.e., media-editing applications) provide graphical designers, media artists, movie and television directors, and other users with the necessary tools to create a variety of media content. These applications give users the ability to edit, combine, transition, overlay, and piece together different media content in a variety of manners to create composite presentations. When combining media to create composite presentations, it is important that all shadows in the resulting composite presentations appear natural in a scene. Prior art methods for creating and controlling shadows for media content fail to provide useful means for creating realistic shadows. Often, a user has to hand draw a shadow, which results in great difficulty for the user and shadows that look unrealistic in a scene. Alternatively, when prior art media-editing applications provide means to control a shadow, they provide no easy way to make the shadow look natural in a composite presentation.

### BRIEF SUMMARY

Embodiments of a media editing application for generating and editing shadows are described herein. The media editing application of some embodiments provides a set of editing tools for creating a composite presentation from first and second media clips, and a preview display area for displaying a preview of the composite presentation. In some embodiments, the media editing application provides a shadow generation tool for generating a shadow for the second media clip and displaying the shadow in the preview display area. The shadow is composited with the first and second media clips to create the composite presentation.

The shadow projection tool of some embodiments includes a set of on-image controls for display in the preview display area near the second media clip. The set of on-image controls can be moved on the preview display area to modify a set of attributes of the shadow. One such control is a blur control that is associated with a blur attribute. The blur attribute defines how blurry the shadow appears in a scene. The blur control in some embodiments includes a selectable item that when moved in one direction increases the blur level such that the shadow appears more blurry in the scene, and that when moved in the opposite direction decreases the blur level such that the shadow appears less blurry.

The set of on-image controls of some embodiments includes a rotational control for rotating the shadow about an origin. In some embodiments, the rotational control can be used to project the shadow in any number of different directions. For example, the application's user can move this control to show the shadow as projecting forwards from an object or projecting backwards away from the object. The set of on-image controls of some embodiments includes a translational control for moving the shadow around in a scene. With the translational control, the shadow can be moved around in the scene independently from the object from which it is generated.

In some embodiments, the set of on-image controls includes a perspective control for changing a perspective value associated with the shadow. The perspective value in some embodiments defines how much the shadow widens or narrows from its base section towards its top section. The perspective control of some embodiments includes a pair of control points that move in unison to change a perspective effect for the shadow (e.g. a widening or narrowing of the shadow to create an appearance of perspective). The perspective value may be associated with a rotation attribute of the shadow. For example, when the rotational control is placed below a transition line, the media editing application may present the shadow as having a wider perspective. Conversely, when the rotational control is placed above the transition line, the media editing application may present the shadow as having a narrower perspective.

The preceding Summary is intended to serve as a brief introduction to some embodiments of the invention, it is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matters are not to be limited by the illustrative details in the Summary, Detailed Description and the Drawing, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates a media-editing application that includes a shadow generation tool of some embodiments.

FIG. 2 conceptually illustrates a process of some embodiments for generating a shadow and providing a set of on-screen controls.

FIG. 3 conceptually illustrates a set of on-screen controls for the shadow generation tool of some embodiments.

FIG. 4 conceptually illustrates an example use of a rotational control of the set of on-screen controls.

FIG. 5 conceptually illustrates an example use of the rotational control of the set of on-screen controls.

FIG. 6 conceptually illustrates an example use of a translational control of the set of on-screen controls.

FIG. 7 conceptually illustrates an example use of a blur control of the set of on-screen controls.

FIG. 8 conceptually illustrates an example use of a perspective control of the set of on-screen controls.

FIG. 9 conceptually illustrates an example use of the rotational control of the set of on-screen controls.

FIG. 10 conceptually illustrates an example use of the rotational control of the set of on-screen controls.

FIG. 11 conceptually illustrates a state diagram of a media-editing application of some embodiments.

FIG. 12 conceptually illustrates an inspector panel associated with the shadow generation tool of some embodiments.

FIG. 13 conceptually illustrates an example use of a blur slider of the inspector panel.

FIG. 14 conceptually illustrates an example use of the blur falloff slider of the inspector panel.

FIG. 15 conceptually illustrates an example use of a perspective slider of the inspector panel.

FIG. 16 conceptually illustrates an example use of the perspective slider of the inspector panel.

FIG. 17 illustrates an example GUI of a media-editing application of some embodiments.

FIG. 18 conceptually illustrates the software architecture of the media-editing application of some embodiments.

FIG. 19 conceptually illustrates an example of an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Embodiments of a media-editing application for generating and editing shadows are described herein. The media-editing application of some embodiments provides a shadow generation tool that can be used to generate a shadow from a media clip (e.g., an image, a video clip) and then modify the generated shadow. In generating the shadow, the media-editing application of some embodiments identifies an object in a media clip, the shape of the object, and then generates a shadow having the same or similar shape.

The shadow generation tool of some embodiments includes a number of different controls to modify the attributes of a shadow. Example attributes includes color, opacity, blur level, position, perspective level, etc. These controls may be shown with the shadow on a canvas (e.g., on a preview display area) so that the user can select and move them to modify the shadow's attributes. Alternatively or conjunctively with these on-canvas controls, the shadow generation tool of some embodiments provides other user interface items (e.g., sliders, input fields) to input values for the shadow's attributes.

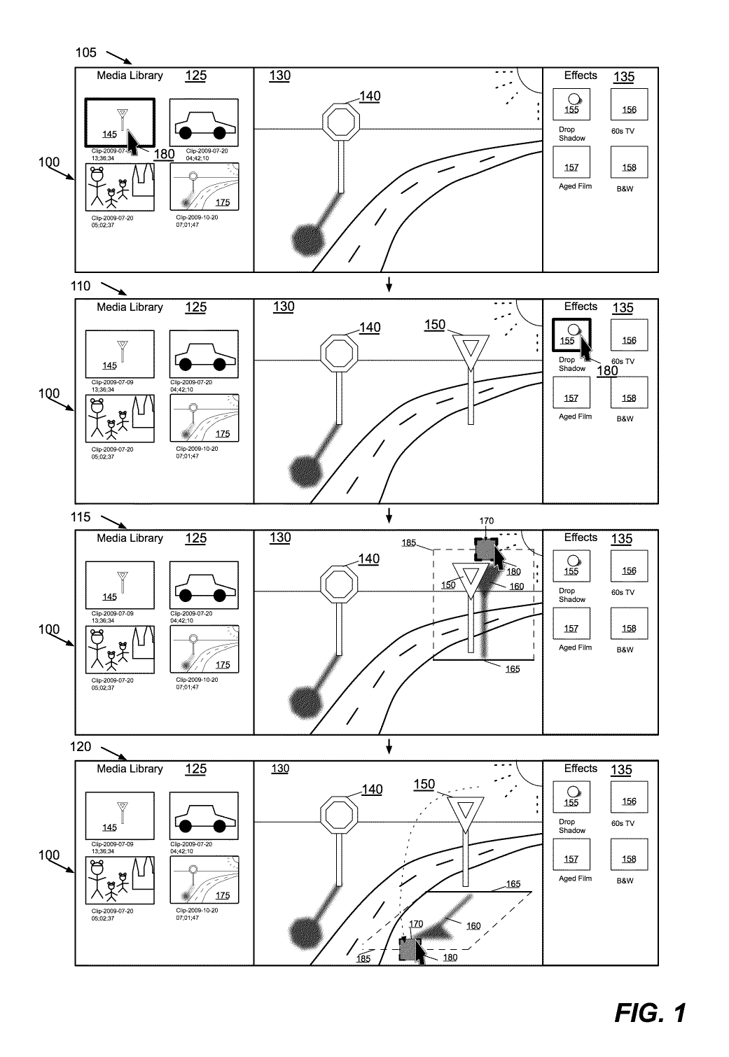

For some embodiments of the invention, FIG. 1 conceptually illustrates an example media-editing application 100 that includes such a shadow generation tool 155. Specifically, this figure illustrates in four operational stages 105-120 how the shadow generation tool 155 can be used to generate a shadow from a media clip and then modify the generated shadow. As shown, the media-editing application 100 includes a media library 125, a preview display 130, and an effects browser 135.

The media library 125 (also referred to as a media display area) is an area of the application's graphical user interface (GUI) through which a user can select media clips to add to a media presentation that the user is compositing with the application. The media library 125 shows representations of media clips that can be composited into a composite media presentation. The media clips can be still images (e.g., green screen removed images), video clips, and/or audio clips that have been imported into the media-editing application 100. In the example of FIG. 1, the clips in the media library are represented as thumbnails that can be selected and added to the composite presentation. However, the clips in the media library 125 may be represented as a list, a set of icons, or some other representation that allows a user to view and select the various clips in the library.

The preview display area 130 (also referred to as a preview window) displays images from media files that the user is skimming through, playing back, compositing, or editing. These images may be from a composite presentation or from a media clip in the media library 125. In some embodiments, the preview display area 130 is a canvas through which an application's user can edit shadows in a composite presentation. To provide such canvas editing features, the media-editing application of some embodiments overlays the preview display area 130 with a set of on-screen controls to modify attributes of a shadow, such as rotational control 170.

The effects browser 135 of some embodiments includes several video effects tools 155-158 for applying effects to a composite presentation. In particular, the effects browser 135 includes the shadow generation tool 155 for generating a drop shadow for a media clip. In this example, three other video effects 156, 157, and 158 tools are shown in the effects browser 135. These other tools are “60s TV” effect tool 156 for making a scene of a video clips appear as a television show from the 1960s, an “Aged Film” effect tool 157 for making the scene appear as an aged footage, and “B&W” effect tool 158 for making the scene black and white. The media-editing application of some embodiments provides additional tools or different sets of tools to apply effects to the media clips in the composite presentation.

Having described several elements of the media-editing application, an example of adding a shadow to a composite presentation and modifying the shadow will now be described by reference to the four stages 105-120 that are illustrated in FIG. 1. The first stage 105 illustrates the preview display area 130 displaying a preview of the composite presentation. The composite presentation includes a media clip 175. The media clip 175 shows a landscape. The landscape may be one captured with a camera e.g., video camera). The landscape includes a road, a stop sign, and a part of the sun. The sun shines over the horizon to cast a shadow in front of the stop sign. In addition, the media library 125 displays a thumbnail representation of a media clip 145. The media clip 145 includes a yield sign. Here, the media clip 145 is an image, the yield sign is an object in the image, and the background of the image is transparent.

To add the media clip 145 to the composite presentation, the application's user selects its thumbnail representation from the media library 125. In the example operation of stage 105, the media-editing application 100 receives a selection of the media clip 145 through an input from a cursor 180. In some embodiments, the media-editing application 100 can receive user input through other means, such as keyboard input or touch screen input.

The second stage 110 shows the media-editing application 100 after adding the selected media clip 145 to the composite presentation. The user might have added the media clip by dragging and dropping the media clip 145 from the media library 125 to a timeline (not shown) that displays a representation of the composite presentation. Alternatively, the user might have added the media clip 145 by selecting a menu item or a shortcut key. In some embodiments, the media-editing application allows the user to add a media clip by dragging and dropping it from the media library 125 onto the preview display area 130.

As the media clip 145 has been added, the preview display area 130 now displays the yield sign 150. The yield sign is superimposed over the landscape scene. Specifically, the yield sign is displayed on the opposite side of the road from the stop sign. The sun shines over the yield sign. However, unlike the stop sign, the yield sign does not have an associated shadow, which makes it appear out of place in the landscape scene.

The third stage 115 shows the media-editing application 100 after applying the shadow effect on the media clip 145 using the shadow generation tool 155. In some embodiments, the shadow effect can be applied by dragging and dropping the shadow generation tool 155 from the effects browser 135 to a timeline (not shown) that displays a representation of the composite presentation. Alternatively, the user might have applied the effect through a menu item or a shortcut key. In some embodiments, the media-editing application allows the user to apply an effect from the effects browser 135 by dragging and dropping it from the effects browser 135 onto the preview display area 130.

As shown in the third stage 115, the application of the shadow effect causes the drop shadow 160 to appear in the preview display area 130. The shadow is generated from the yield sign. That is, it appears in the scene with the same or similar shape as the yield sign. The shadow is associated with a predefined set of attributes. For example, the shadow is colored and blurred, similar to a shadow in the real world. The media-editing application of some embodiments maintains the predefined set of attributes to reflect these real-world characteristics, such as a color value, a blur value, a blur falloff value, a perspective value, and a rotational position. The generation, manipulation, and presentation of the set of attributes will be discussed in conjunction with later figures and examples.

In some embodiments, the media-editing application generates the shadow from an object and places the shadow in the scene at a default origin position. The default origin position of some embodiments is a position nearby the media clip (e.g., the object) from which the shadow was generated. From this nearby position, the shadow will be cast from the default origin. For example, the drop shadow 160 is generated from the yield sign 150 of the selected media clip 145 and placed in a default origin position.

As shown in the third stage 115, the drop shadow 160 is shown in the scene behind the yield sign and offset downwards and rightwards from the yield sign. The drop shadow 160 is cast from said default origin position in vertical alignment with the yield sign 150. The default origin position of some embodiments places the shadow in horizontal alignment behind the object from which it was generated such that the shadow cannot be seen or is barely visible until it has been moved from behind the object. In addition, the default origin position may place the shadow slightly below, above, or to the side of the media clip from which it was generated. In the examples discussed below, the default origin position will be slightly offset vertically and/or horizontally so that generated shadows can be more easily seen.

In the third stage 115, the drop shadow 160 is shown with a frame 165 (e.g., a quadrilateral frame or bounding box). The frame surrounds the drop shadow. The location of the frame indicates the position of the shadow, and the shape of the frame indicates the orientation of the shadow. In some embodiments, the frame 165 represents the outline of an image with the shadow. For example, the drop shadow 160 is the visible portion of the image, while the remaining portion is the transparent portion of that same image. This is because the media-editing application generated the image with the shadow from an image (i.e., the media clip 145) in which the yield sign is the only visible object. The initial size of the frame 165 is directly correlated to the size of the image (i.e., the media clip 145).

In the third stage 115, the drop shadow 160 is not aligned with the shadow of the stop sign 140. As mentioned above, the shadow generation tool 155 of some embodiments includes a number of controls to modify attributes of the drop shadow 160. One such control is the rotational control 170 that appears over the shadow in the preview display area 130. This control can be selected and moved to rotate the drop shadow 160 about its origin position. For example, the user can select and move this control to specify whether the shadow is cast in front of the yield sign, to the side of yield sign, behind the yield sign, etc. In this example, the rotational control 170 appears on the top edge 185 of the frame 165. The control is also centered on the top edge 185. The third stage 115 illustrates the selection of the rotational control 170.

The fourth stage 120 illustrates the movement of the rotational control 170 from one location to another location on the preview display area 130. Specifically, the rotational control 170 has been moved from being above the yield sign 150 to being below the yield sign. This movement results in the drop shadow being rotated about the yield sign. Specifically, the user has moved the control such that the drop shadow 160 matches the shadow of the stop sign 140. The drop shadow 160 is now at an angle similar to the shadow of the stop sign 140.

As shown in the fourth stage 120, the rotational control 170 is unique in that it does not simply rotate the drop shadow 160. Instead, it changes the projection of that shadow. In addition, the shadow generation tool 155 modifies the frame 165 from a rectangle to a parallelogram to match the changed projection of the drop shadow 160. The bottom edge of the frame (also referred to as a frame baseline) remains in the same position. The top edge 185 of the frame (also referred to as a cast line) is now below the bottom edge. The top edge 185 is still parallel to the bottom edge but is moved slightly to the left of the bottom edge. The shadow is projected from the bottom edge towards the top edge 185. Accordingly, the rotational control 170 in some embodiments is a projection tool that allows the shadow to be projected in any number of different directions without making it appear unnatural in a scene.

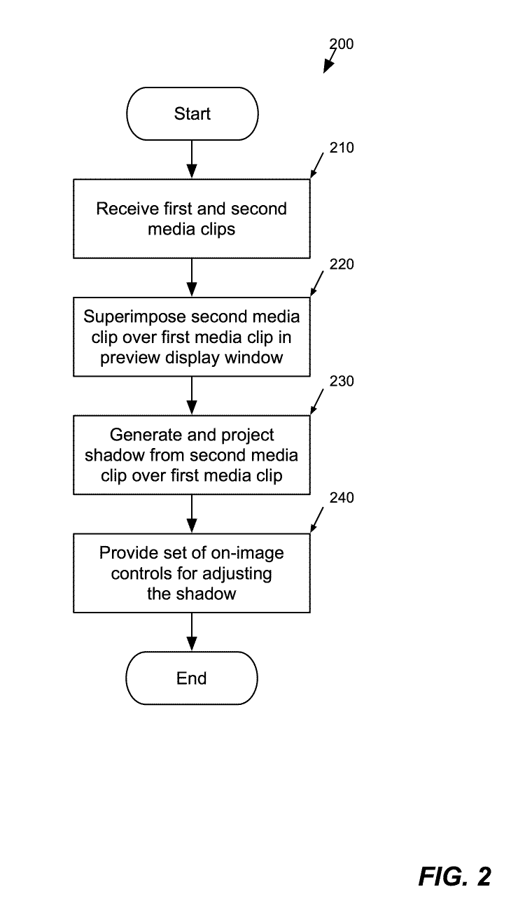

Having described an example of adding and modifying a shadow, an example shadow generation process will now be described. FIG. 2 conceptually illustrates a process 200 that some embodiments perform to generate and modify a drop shadow. In some embodiments, the process 200 is performed by the media-editing application. In other embodiments, the shadow generation tool 155 performs the process 200 directly. The process 200 begins when it receives (at 210) first and second media clips.

The process 200 then superimposes (at 220) the second media clip over the first media clip in a preview display area, in the example illustrated in FIG. 1, the user adds the first and second media clips to the composite presentation. The second media clip 145 is superimposed over the first media clip 175 in the preview display area 130.

At 230, the process then generates a shadow from the second media clip, and projects the shadow over the first media clip. In some embodiments, the process 200 generates the shadow from only non-transparent portions of the second media clip. In some embodiments, the process 200 creates the shadow from only a subset of a set of objects within the second media clip. As shown in the third stage 115 of FIG. 1, the drop shadow 160 is initially projected in vertical alignment with the second media clip 145 with its origin position offset to the right and downwards from yield sign 150. In some embodiments, the drop shadow may be projected at different locations and different angles according to varying configuration presets.

The process next provides (at 240) a set of on-screen controls to allow the user to modify the drop shadow. One such control is a rotational control that appears over the scene in the preview display area. As mentioned above by reference to stage 115 of FIG. 1, the rotational control can be selected and moved to project the drop shadow in any number of different directions without making it appear unnatural in a scene.

In conjunction with the rotational control, or instead of it, the process of some embodiments provides other controls to modify other attributes of a shadow. For example, the process in some embodiments provides a translational control to change the origin position of the shadow in a scene, a blur control to change the blur level of the shadow, and/or a perspective control to change the perspective level of the shadow. These controls may be provided as on-screen controls that appear over a scene in the preview display area. Alternatively, the process of some embodiments provides other user interface items (e.g., sliders, input fields) to define the shadow's attributes.

Several more examples of generating and modifying shadows are described below. Specifically, section I describes several example canvas tools for modifying attributes of a shadow. This is followed by section II that describes several example operations performed with the on-screen controls. Section III then introduces an inspector tool for displaying and manipulating numerical values associated with a drop shadow. Section IV then describes an example GUI of a media-editing application of some embodiments. Section V then describes the software architecture of the media-editing application of some embodiments. Section VI then describes an electronic system, which implements some embodiments of the invention.

### I. Example Canvas Tools

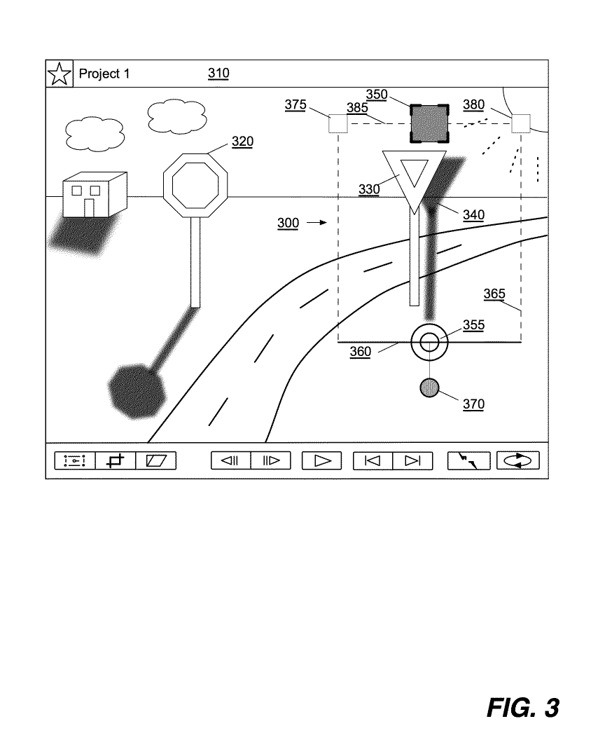

Several more examples of generating and modifying shadows will be described below. However, before describing these examples, an example shadow generation tool of some embodiments will now be described. FIG. 3 conceptually illustrates a shadow generation tool that includes a set of on-screen controls 300 to modify the attributes of a drop shadow. As shown, the figure includes a preview display area 310 and the set of on-screen controls 300.

The preview display area 310 is the same as the one described above by reference to FIG. 1. Here, the preview display area 310 displays a first media clip 320 composited with a second media clip 330, a drop shadow 340 generated from the second media clip 330 by the shadow generation tool 155, and the set of on-screen controls 300. The first media clip 320 includes a road, a horizon, a house, a sun, a shadow cast by the house, clouds, a stop sign, and a shadow cast by the stop sign.

In some embodiments, the set of on-screen controls 300 appears upon applying a drop shadow effect using a shadow generation tool from an effects library of a media-editing application. The set of on-screen controls 300 can be used to modify different attributes of the drop shadow. In some embodiments, the attributes of the drop shadow include a rotational position, an origin position value, a blur value, and a perspective value. When a media clip includes multiple objects, the attributes of the objects' shadows can be modified in unison with the set of on-screen controls 300. In the example illustrated in FIG. 3, the set of on-screen controls 300 includes (1) a rotational control 350, (2) a translational control 355, (3) a blur control 370, and (4) perspective controls 375 and 380. The set of on-screen controls 300 is associated with a frame 365 having a cast line 385 and a baseline 360. The baseline 360 is shown as a solid line, while the remaining edges of the frame 365, including the cast line 385, are shown with dashed lines. The media editing application of some embodiments presents the baseline 360 different from other edges because the baseline 360 is essentially the transition line where the shadow changes from being in front of an object to the back of the object, or vice versa.

The rotational control 350 allows for rotation of the drop shadow 340 about an axis. In some embodiments, the axis can be an X-axis (i.e. horizontal axis) with an incident Y-axis (i.e. vertical axis). Alternatively, in other embodiments, the axis can include any plane that can exist in an X, Y, or Z coordinate system. By rotating the rotational control 350, the user changes the rotational position attribute of the drop shadow 340. In some embodiments, the origin of the axis on which the rotational control 350 is rotated is defined at or near the base of the shadow object. In the example of FIG. 3, the origin of the axis is at or near to the midpoint of the baseline 360.

As shown in FIG. 3, the rotational control 350 is displayed over the mid-point of the cast line 385. The rotational control 350 is unique in that it does not simply rotate the drop shadow 340. Instead, it changes the projection of that shadow. For instance, when the rotational control 350 is moved below the baseline 360, the drop shadow 340 is shown as projecting out in front of the associated object. When the control is moved above the baseline 360 but below the height of the image that contains the shadow, the shadow is shown as projecting out from behind the associated object. When the rotational control 350 is moved to the side, the shadow is shown as projecting out to the side of the object. During movement of the rotational control 350, the media-editing application may continuously redraw the drop shadow 340 such that the shadow is cast towards the location of the rotational control 350 from the origin of the axis. The axis about which the rotational control 350 rotates in some embodiments is an X and Y-axis with horizontal and vertical coordinates.

The translational control 355 can be selected and moved to relocate the drop shadow 340. In particular, the user can select this control and move it anywhere on the preview display area 310 to place the drop shadow at the corresponding location in the scene. The translational control of some embodiments is associated with an origin position attribute that defines the location of the shadow in the scene. In the example of FIG. 3, the translational control 355 is shown at or near the mid-point of the baseline 360. In conjunction with the translational control 355, the media-editing application in some embodiments allows the user to select and move the frame 365 to modify the same origin position attribute. During movement of the translational control 355, the media-editing application may continuously redraw the drop shadow 340 at different locations in accord with the movement.

The blur control 370 allows for dynamic manipulation of the blur level of the drop shadow 340. The shadow projection tool 155 blurs the drop shadow 340 with the first media clip 320 at various levels according to the blur control 370. In some embodiments, the blur control 370 can be selected and moved in one of two different directions (e.g., up or down, left or right) from a particular location (e.g., the location of the shadow). By changing the distance between the blur control 370 and the particular location, the user can change the blur level of the drop shadow.

In the example of FIG. 3, the blur control 370 includes a selectable item (e.g., the circle) and a vertical line extending from the baseline 360. The line extends from a location at or near the mid-point of the baseline 360, and provides a visual indication of the distance between the selectable item and the location. The selectable item of the blur control 370 can be dragged up from or down to that location (e.g., along the line extended from the selectable item's location from the mid-point of the baseline 360). In some embodiments, when the selectable item 370 is dragged closer to the location, the drop shadow 340 becomes less blurry. Conversely, when the blur control 370 is dragged away from the location, the drop shadow 340 becomes more blurry.

The perspective controls 375 and 380 allow for manipulation of a perspective value for the drop shadow 340. The media-editing application of some embodiments projects the drop shadow with varying perspective values. In some embodiments, the perspective value simulates a three-dimensional effect for a drop shadow. For example, at high perspective levels, the shadow will appear to be cast farther away from or closer to the viewer, depending on the location of the rotational control 350 relative to the baseline 365. When the rotational control 350 is placed at a distance above the baseline that is greater than the height of the media clip from which the drop shadow was generated, a non-zero perspective value (e.g. 0.75) results in a drop shadow that appears wider. When the rotational control 350 is placed at a distance above the baseline that is less than the height of the media clip from which the drop shadow was generated, a non-zero perspective value results in a drop shadow that appears narrower and cast farther away from the viewer. When the rotational control 350 is placed below the baseline, a non-zero perspective value results in a drop shadow that appears wider and cast closer to the viewer. Lower perspective values (e.g. 0.1) result in less widening or narrowing effects. As shown in FIG. 3, the perspective controls 375 and 380 are a pair of control points that are placed at the corners of the frame 365 on the cast line 385. As the shadow appears narrower or wider according to the conditions discussed above, the perspective controls 375 and 380 become closer together or farther apart on the cast line 385. In the example of FIG. 3, the drop shadow's perspective value is modified when the control 375 is moved inwards, towards the drop shadow 340. To maintain a natural look of a shadow, the movement of one control 375 or 380 results in the movement of the other control. In some embodiments, the media-editing application provides a selectable option to move one control without moving the other.

The set of on-screen controls 300 is conceptually illustrated in a state where no user input is being received. While the set of on-screen controls 300 operates by receiving user input, one of ordinary skill in the art will recognize that similar operations may be performed by using touchscreen operations, and that additional operations (e.g., selecting a menu option, using a hotkey, etc.) may be performed in the GUI of some embodiments in order to achieve this same result. In fact, this application shows many such operations as being performed in a particular manner (e.g., with a cursor), and one of ordinary skill in the art will recognize that these operations may be performed in a variety of different ways through a variety of different input devices in various different embodiments.

In the example of FIG. 3, the set of on-screen controls 300 is shown with a frame 365 (e.g., a quadrilateral frame or bounding shape). The frame 365 surrounds the drop shadow. The location of the frame 365 indicates the position and the orientation of the shadow. In some embodiments, the initial size of the frame 365 corresponds to the size of the media clip (e.g., image size, frame size) from which the shadow was generated. As mentioned above, the media-editing application of some embodiments allows the user to select and move to the frame 365 and its baseline 360 to modify the same origin position attribute controlled by the translational control 355. The segment of the frame 365 opposite the baseline 360 serves as a cast line 385 towards which the shadow generation tool 155 casts the drop shadow 340. When the cast line 385 is moved below the baseline 360, the shadow generation tool 155 casts the shadow downwards towards the cast line 385.

One of ordinary skill in the art will also recognize that the media-editing application described is an example application and that it can be defined in a number of different ways. For instance, in some embodiments, the media application might provide controls to control one set of attributes while not providing controls to control another set of attributes. In addition, the media-editing application of some embodiments allows its user to specify which controls are shown on a canvas (e.g., the preview display area). For example, the media-editing application may include a selectable item (e.g., toggle switch, check box) to hide or reveal one or more of the controls described above.

In addition, one of ordinary skill in the art will recognize that the set of on-screen controls 300 shown in FIG. 3 is a conceptual illustration, and different embodiments may graphically render the set of on-screen controls 300 in a different manner. For example, in some embodiments, the media-editing application of some embodiments modifies the appearance of a control when it is selected and/or moved around the canvas. In addition, the shape or the look of the controls can be modified in various different ways. For example, instead of a rectangular or circular control, the media-editing application might provide a different shape (e.g., triangle, star) with text, color, and/or pattern that indicate the associated attribute.

### II. Example Operations

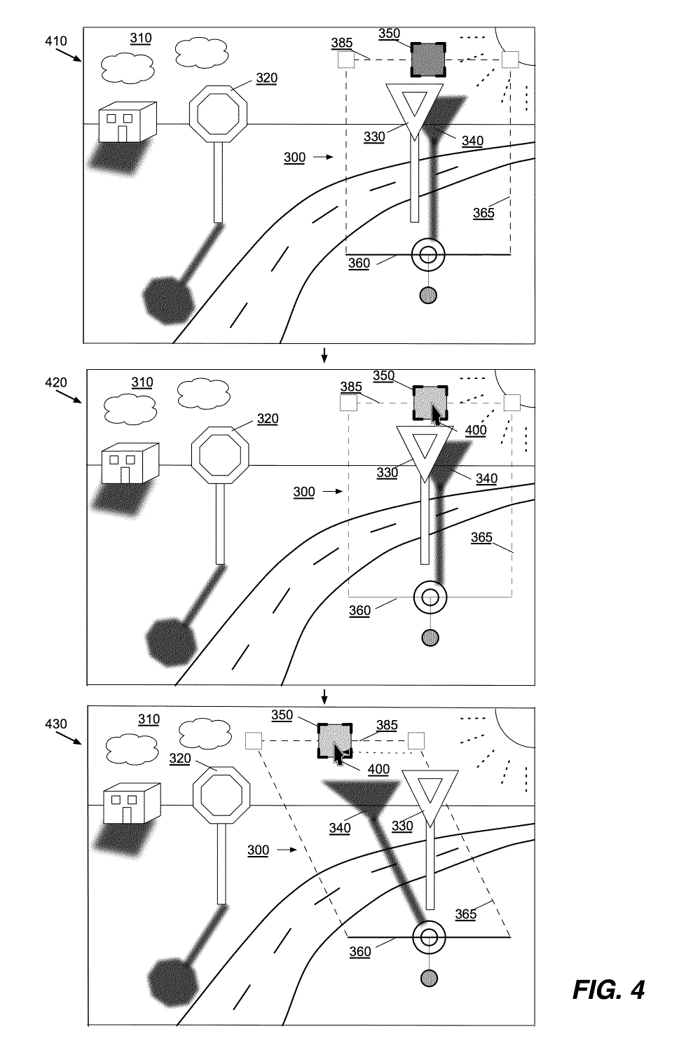

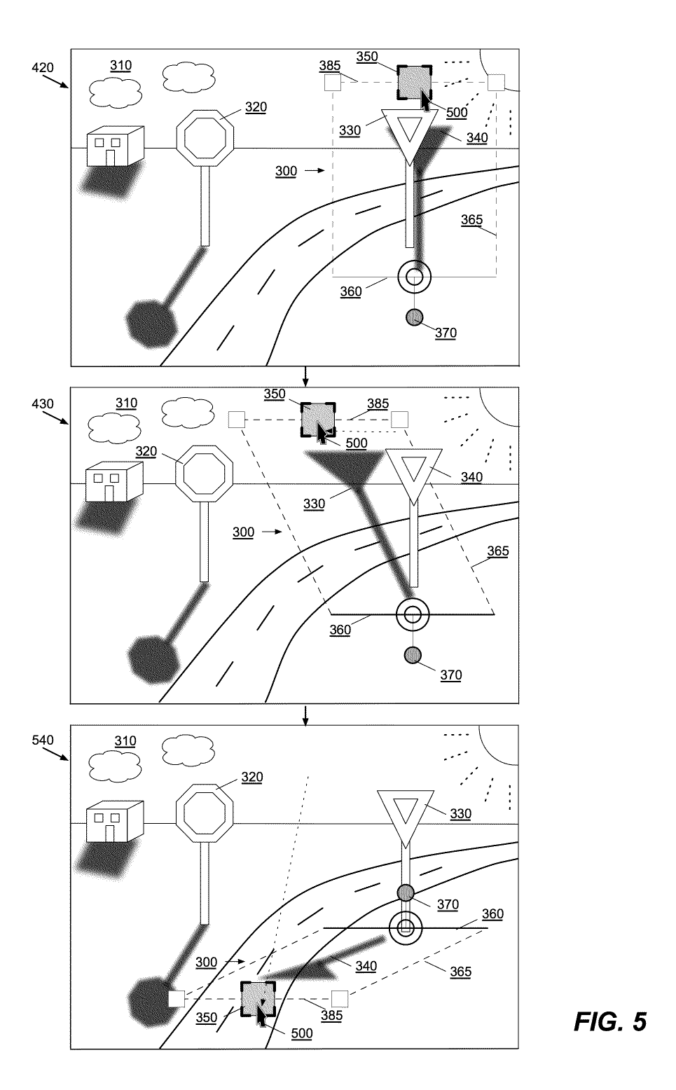

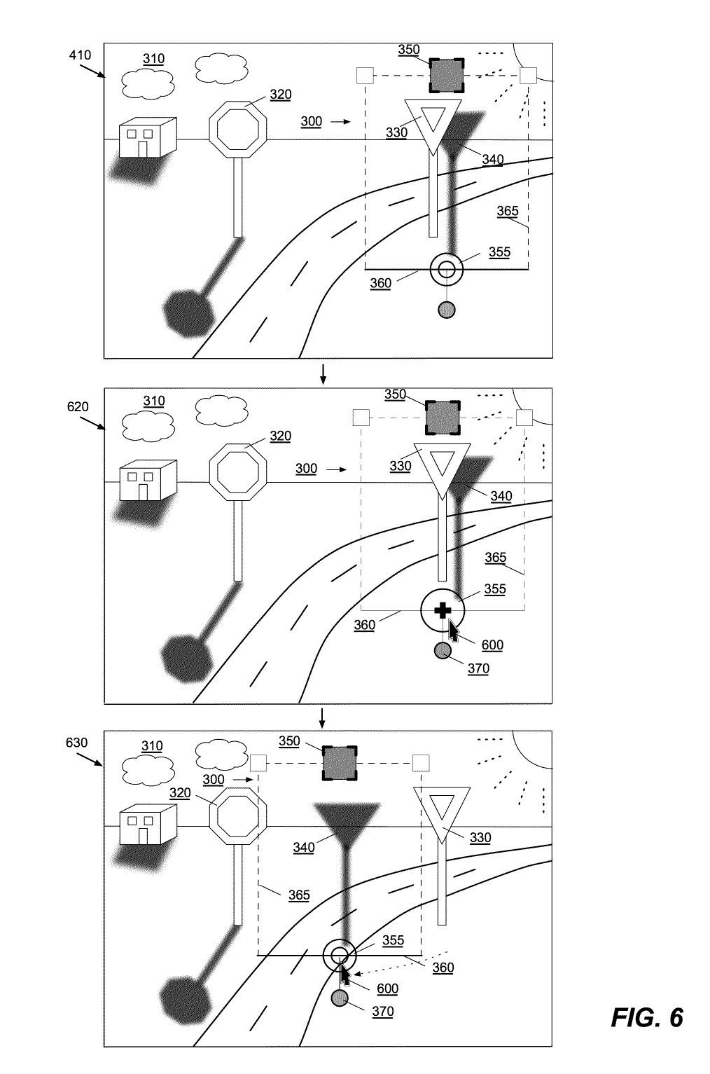

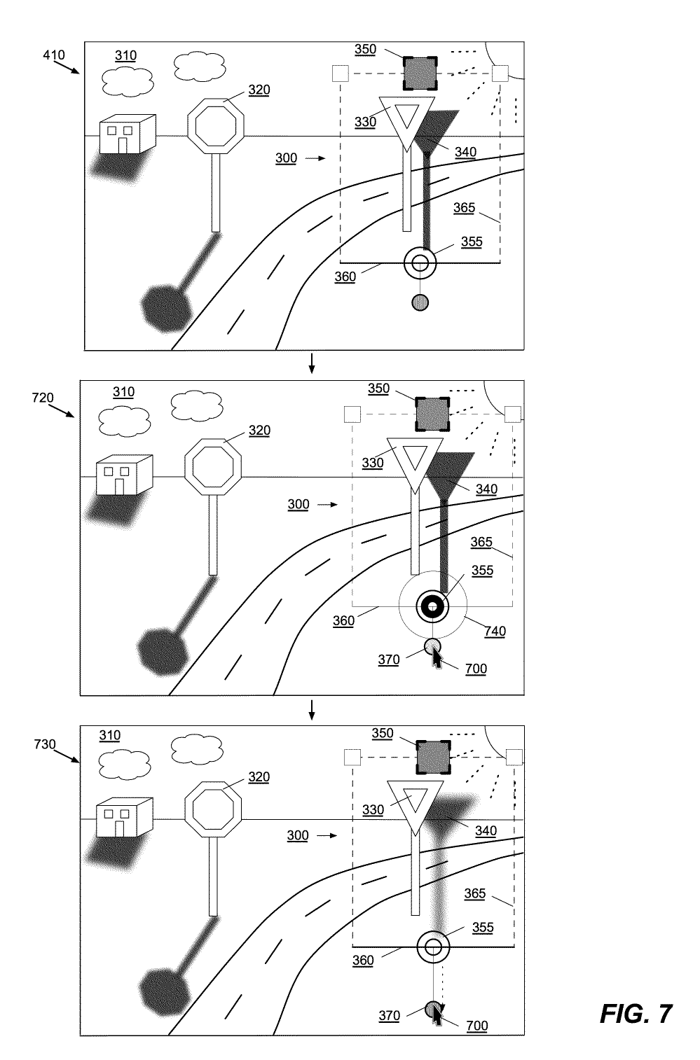

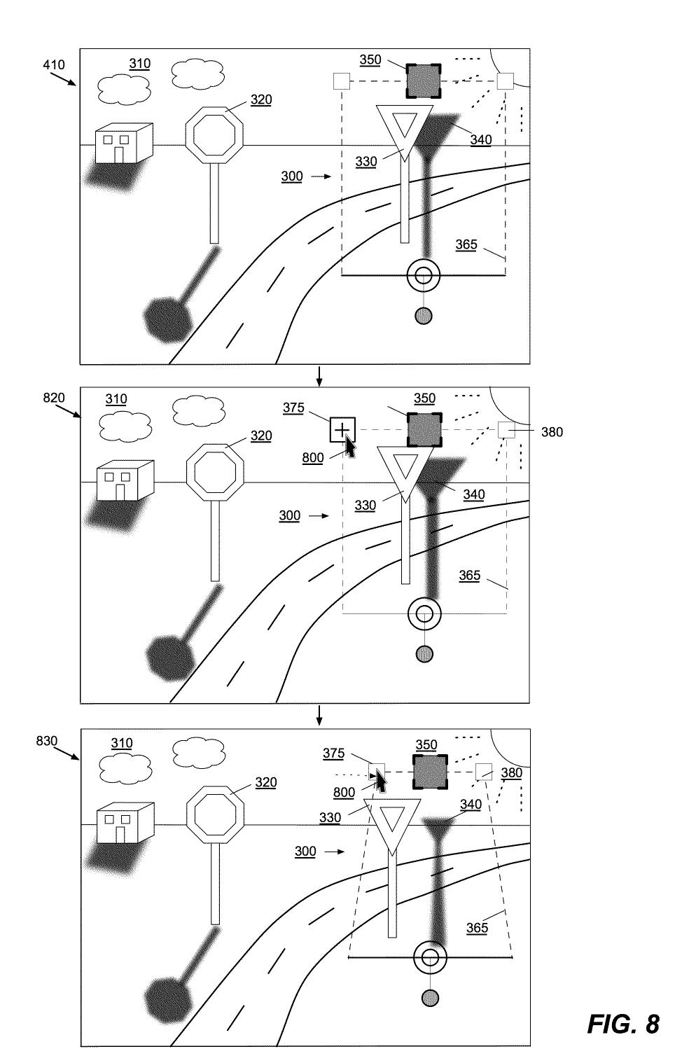

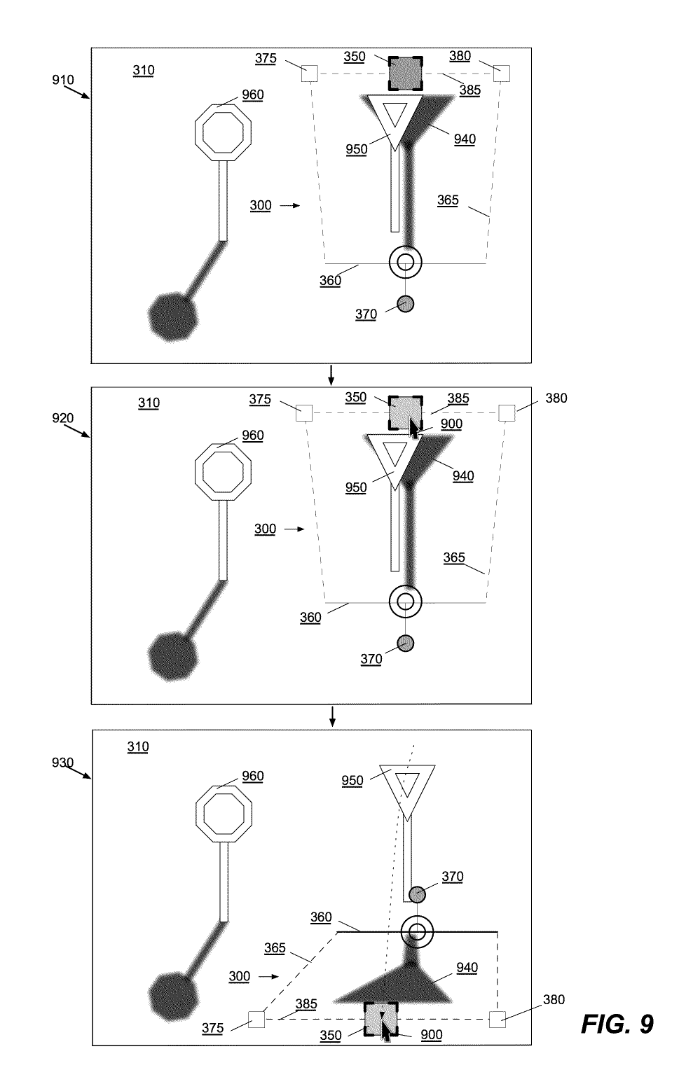

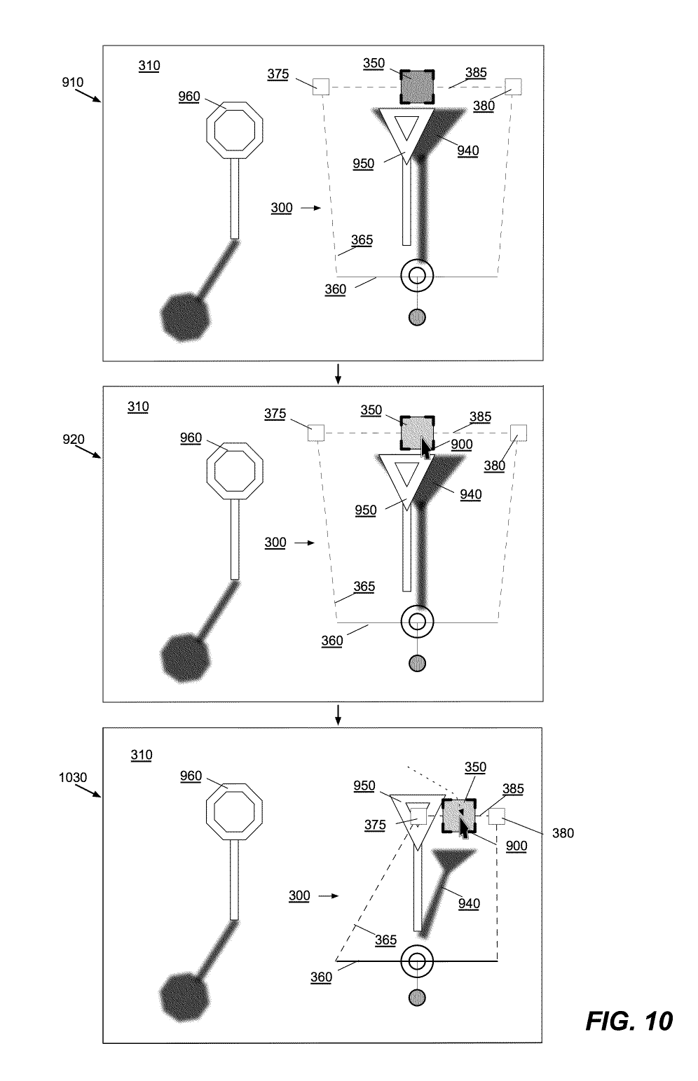

The previous section described an example set of on-screen controls 300 for modifying attributes of a shadow. Several examples operations using the set of on-screen controls will now be described by reference to FIGS. 4-10. Specifically, the rotational control 350 will be discussed below by reference to FIGS. 4 and 5. The translational control 355 will be discussed below by reference to FIG. 6. The blur control 370 will be discussed below by reference to FIG. 7. The perspective controls 375 and 380 will be discussed below by reference to FIG. 8. Use of the rotational control 350 in conjunction with a default perspective value will be discussed by reference to FIGS. 9 and 10.

A. Rotational Control

FIG. 4 provides an illustrative example of using the rotational control 350 to change the angle of a drop shadow 340. Three stages 410, 420, and 430 of the media-editing application are shown in this figure. Stages 410, 420, and 430 conceptually illustrate the preview display area 310 at first, second, and third periods of time, respectively.

At the first stage 410, the preview display area 310 shows a scene from a first media clip 320, an object from a second media clip 330, the object's drop shadow 340, and the set of on-screen controls 300. In the first stage 410, the drop shadow 340 has been generated with the shadow generation tool 155. As mentioned above by reference to FIG. 1, the media-editing application of some embodiments identifies an object in a media clip, the shape of the object, and then generates a shadow having the same or similar shape.

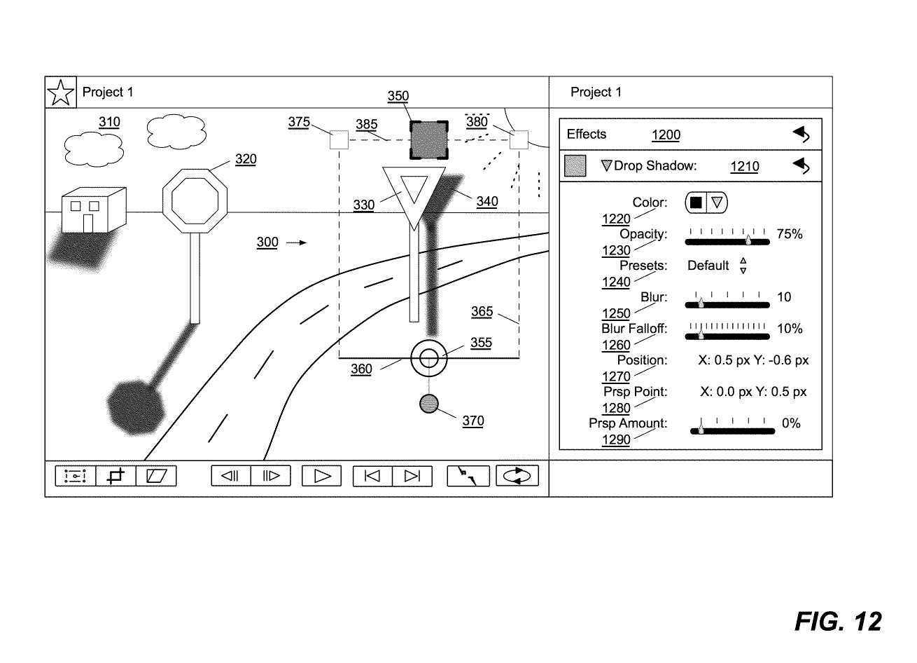

In some embodiments, the shadow generation tool 155 generates the drop shadow 340 according to a default-preset configuration (e.g., left leaning shadow or right leaning preset configuration). Several examples of different preset configurations will be described by reference to FIG. 12 below. The media-editing application of some embodiments generates the shadow from an object and places the shadow in the scene at a default origin position. For example, the drop shadow 340 is shown in the scene behind the yield sign and offset downwards and rightwards from the yield sign. In addition, the drop shadow 340 is projected in vertical alignment with the object from which it was generated. The default origin position of other embodiments places the shadow in horizontal alignment behind the object from which it was generated and displaced vertically slightly below the object from which it was generated.

The first stage 410 illustrates the set of on-screen controls 300 prior to selection of rotational control 350. At the first stage 410, the preview display area 310 shows the first media clip 320, the second media clip 330, the drop shadow 340, and the set of on-screen controls 300. The second stage 420 illustrates the rotational control 350 after its selection. Here, the application's user might have selected the rotational control 350 through a select and hold operation (click and hold using a cursor controller). The selection resulted in shadow generation tool 155 changing the appearance of the rotational control 350. Specifically, in stage 420, the rotational control 350 has a lighter color than in stage 410. In some embodiments, the rotational control is a first color (e.g., dark blue) when not receiving user input, and a different second color (e.g., light blue) when receiving user input.

The third stage 430 illustrates the preview display area 310 after moving the rotational control 350 from one location to another. Specifically, the rotational control 350 has been moved to the left (as indicated by the dashed arrow near the cursor 400). As shown, the drop shadow 340 is no longer aligned with the second media clip 330. The shadow generation tool 155 has altered the appearance of the drop shadow 340 such that its angle is in alignment with the rotational control's 350 new position. After moving the rotational control 350, the drop shadow 340 in stage 430 appears as if it is cast from a light source on the opposite side of the baseline 360 from the rotational control 350. As the user changes the location of the rotational control 350, the shadow generation tool 155 alters the appearance of the drop shadow 340 to emulate the rotation of a light source for the second media clip 330 without the user having to interact with an additional light source object. As the rotational control 350 changes position, the shadow generation tool 155 of some embodiments changes a rotational position attribute of the drop shadow 340.

In addition, the shadow generation tool 155 has altered the shape of the drop shadow 340 in order to maintain an appearance of perspective at the new rotational control 350 position in several ways. First, the shadow generation tool 155 has recast the shadow at an angle based on the angle between the baseline 360 and the rotational control 350. Second, the shadow generation tool 155 has maintained the drop shadow's shape such that the top of the drop shadow 340 remains in horizontal alignment with the cast line 385). Third, the shadow generation tool 155 has increased the length of the drop shadow 340 to account for the longer relative distance between the rotational control 350 and the baseline 360 in stage 430. Fourth, the shadow generation tool 155 has altered the shape of the drop shadow 340 in accordance with the new orientation provided by the new position of the rotational control 350 in stage 430 (e.g., the triangular portion of the drop shadow 340 is not equilateral like the triangular portion of the yield sign of the second media clip 330). Furthermore, the shadow generation tool 155 has altered the appearance of the frame 365 in accordance with the new position of the rotational control 350 (e.g., the frame 365 has a parallelogram shape in stage 430 whereas the frame 365 had a rectangular shape in stage 420).

FIG. 5 provides another example of using the rotational control 350 to change the angle of a drop shadow 340. Three operational stages 420, 430, and 540 of the media-editing application are shown in this figure. The first two stages 420 and 430 are the same as the ones illustrated in FIG. 4. Specifically, in the first stage 420, the rotational control 350 has been selected, and in the second stage 430, the rotational control has been moved towards the left-hand side of the preview display area 310.

The third stage 540 illustrates the preview display area 310 after moving the rotational control downwards towards the bottom of the preview display area 310. As shown in stage 540, the movement resulted in the drop shadow 340 appearing as it is being cast in front of the yield sign and not behind it.

In the third stage 540, the shadow generation tool 155 has altered the shape of the drop shadow 340 in order to maintain an appearance of perspective at the new rotational control 350 position in front of the yield sign in several ways. First, the shadow generation tool 155 has recast the shadow at an angle based on the angle between the baseline 360 and the rotational control 350. Second, the shadow generation tool 155 has maintained the drop shadow's shape such that the top of the drop shadow 340 remains in horizontal alignment with the cast line 385. Third, the shadow generation tool 155 has decreased the length of the drop shadow 340 to account for the shorter relative distance between the rotational control 350 and the baseline 360 in stage 540. Fourth, the shadow generation tool 155 has altered the shape of the drop shadow 340 in accordance with the new orientation provided by the new position of the rotational control 350 in stage 540 (e.g., the triangular portion of the drop shadow 340 is not equilateral like the triangular portion of the yield sign of the second media clip 330).

In addition, the shadow generation tool 155 has altered the appearance of the frame 365 in accordance with the new position of the rotational control 350 (e.g., the frame 365 has a downward parallelogram shape in stage 540 whereas the frame 365 had an upward parallelogram shape in stage 430). In the embodiment illustrated in stage 540, the blur control point 370 is displayed above the baseline 360 and the frame baseline 360. In some embodiments, the set of on-screen controls does not invert the location of the blur control point 370 when the rotational control 350 is moved below the frame baseline 360.

B. Translational Control

FIG. 6 provides an illustrative example of using the translational control 355 to change the origin position of the drop shadow 340. Three operational stages 410, 620 and 630 of the media-editing application are shown in this figure. The first stage 410 is the same as the one illustrated in FIG. 4. The first stage 410 illustrates the set of on-screen controls 300 prior to selection of translational control 355. At the first stage 410, the preview display area 310 shows the first media clip 320, the second media clip 330, the drop shadow 340, and the set of on-screen controls 300.

The second stage 620 illustrates the translational control 355 after its selection. Here, the application's user might have selected the translational control 355 through a select and hold operation (click and hold using a cursor controller). The selection resulted in shadow generation tool 155 changing the appearance of the translational control 355. Specifically, in stage 620, the translational control's 355 appearance has been modified to include an expanded circular boundary and a cross (i.e., a plus sign) at its center. In addition, the shadow generation tool 155 dims the frame 365. Though not illustrated in FIG. 6, if the cursor 600 had been providing input to the frame baseline 360 or the frame 365, then some embodiments would display the same modified translational control 355 and dimmed frame 365 shown in stage 620. In some embodiments, the shape of the translational control 355 does not change when receiving input to the translational control 355, the frame baseline 360, or the frame 365, rather the shadow generation tool 155 provides alternative means of showing that the set of on-screen controls 300 are receiving input (e.g. the translational control 355, the frame baseline 360, or the frame 365 are displayed in a different color).

The third stage 630 illustrates the preview display area 310 after moving the translational control 355 downwards and to the left (as indicated by the dashed arrow near cursor 600). As shown in stage 630, the drop shadow 340 and the set of on-screen controls 300 have moved with the translational control 355. The shadow generation tool 155 has made no changes to the shape or orientation of the drop shadow 340. Instead, the shadow generation tool has merely changed the origin position of the drop shadow. Because cursor 600 is no longer providing input to the rotational control in stage 630, the translational control 355 has regained the shape it had in stage 410 and the frame 365 has returned to an undimmed state, as in stage 410.

C. Blur Control

FIG. 7 provides an illustrative example of using the blur control 370 to change the blurring of drop shadow 340 with the first media clip 320. Three operational stages 410, 720, and 730 of the media-editing application are shown in this figure. The first stage 410 is the same as the one illustrated in FIG. 4. For purposes of illustration, the drop shadow 340 is illustrated darker in stages 410 and 720 in order to make the blur effect clearer for the reader. The first stage 410 illustrates the set of on-screen controls 300 prior to selection of blur control 370. At the first stage 410, the preview display area 310 shows the first media clip 320, the second media clip 330, the drop shadow 340, and the set of on-screen controls 300.

The second stage 720 illustrates the blur control 370 after its selection. Here, the application's user might have selected the blur control 370 through a select and hold operation (click and hold using a cursor controller). The selection resulted in shadow generation tool 155 changing the appearance of the translational control 355 and the blur control 370. Specifically, in stage 720, the translational control's 355 appearance has been modified to include an additional circle 740 and the blur control 370 has a lighter color than in stage 410. For example, there is a change in color to a circle shape associated with the blur control 370.

As shown in the second stage 720, the selection of the blur control 370 resulted in the appearance of the outer circle 740. In some embodiments, the outer circle changes in diameter as the selectable item associated with the blur control 370 is moved away or towards the translational control's 355 or the location at or near the mid-point of the baseline 360. For example, the outer circle 740 may become larger when the selectable item is moved away from the translational control 355 and smaller when the selectable item is moved towards the translational control 355. The outer circle 740 may also disappear once the control is deselected. In some embodiments, the selection of the blur control 370 does not result in any change to the appearance of the translational control 355.

The third stage 730 illustrates the preview display area 310 after moving the blur control 370 downwards (as indicated by the dashed arrow near cursor 700). Moving the blur control point 370 further from the baseline 360 results in increased blurring for the drop shadow 340. As shown in stage 730, the drop shadow 340 is blurrier than in stage 720. In some embodiments, the cursor 700 would have performed a drag and drop operation between stages 720 and 730 to cause the blur control 370 to move downwards as shown in stage 730. Because cursor 700 is no longer providing cursor input to the rotational control in stage 730, the blur control 370 has regained its darker color that it had in stage 410 and the translational control 355 has returned to the shape it had in stage 410

D. Perspective Control

FIG. 8 provides an illustrative example of using the perspective control 375 to change the perspective of the drop shadow 340. Three operational stages 410, 820, and 830 of the media-editing application are shown in this figure. The first stage 410 is the same as the one illustrated in FIG. 4. At the first stage 410, the preview display area 310 shows the first media clip 320, the second media clip 330, the drop shadow 340, and the set of on-screen controls 300.

The second stage 820 illustrates the perspective control 375 after its selection. Here, the application's user might have selected the perspective control 375 through a select and hold operation (click and hold using a cursor controller). The selection resulted in shadow generation tool 155 changing the appearance of the perspective control 375. Specifically, in stage 820, the perspective control's 375 appearance has been modified such that perspective control 375 is larger and includes a cross (i.e. a plus sign). The shadow generation tool 155 does not modify the appearance of perspective control 380 because it is not receiving user input from cursor 800. In some embodiments, the shape of the perspective control 375 does not change when receiving user input, rather the shadow generation tool 155 provides alternative means of showing that the set of on-screen controls 300 are receiving user input (e.g. the shadow generation tool 155 changes the color of the perspective control 375).

The third stage 830 illustrates the preview display area 310 after moving the perspective control 375 to the right (as indicated by the dashed arrow near cursor 800). As shown in stage 830, the shadow generation tool 155 has modified drop shadow 340 to have a narrower perspective in line with the trapezoidal shape of the frame 365. Specifically, the triangular portion of the drop shadow 340 is relatively narrower than the stem portion of the drop shadow 340. The narrowing and widening effect produced by the shadow generation tool 155 allows a user to easily modify the perspective of drop shadow 340. For instance, the perspective control 375 can be used to make a shadow appear to be cast further in the distance as illustrated in stage 830. In addition, the shadow generation tool 155 adjusts perspective control 380 to be closer to perspective control 375.

In some embodiments, the cursor 800 would have performed a drag and drop operation between stages 820 and 830 to cause the perspective control 375 to move to the right as shown in stage 830. Because cursor 800 is no longer providing cursor input to the rotational control in stage 830, the perspective control 375 has regained the shape it had in stage 410.

E. Preserving Perspective with Rotational Control

FIG. 9 provides an illustrative example of using the rotational control 350 of the set of on-image controls 300 to rotate a drop shadow 940. Three operational stages 910, 920, and 930 of the media-editing application are shown in this figure.

At the first stage 910, the preview display 310 shows a first media clip 960 of a stop sign, a second media clip 950 of a yield sign, a drop shadow 940, and the set of on-image controls 300. Unlike previous examples, the first media clip 960 includes only a stop sign and its shadow. The first stage 910 illustrates the set of on-image controls 300 where no input is being received and the drop shadow 940 has recently been generated by the shadow projection tool 155 according to a default-preset configuration. In some embodiments, the default-preset configuration includes a default perspective value that can be manipulated through the perspective controls 375 and 380. As shown in stage 910, the drop shadow 940 includes a default perspective value of 0.5 and the rotational control 350 is at a distance above the baseline 360 that exceeds the height of the media clip, thus the drop shadow 940 has a widened perspective in stage 910.

The second stage 920 illustrates the rotational control 350 after its selection. Here, the application's user might have selected the rotational control 350 through a select and hold operation (click and hold using a cursor controller). The selection resulted in shadow generation tool 155 changing the appearance of the rotational control 350. Specifically, in stage 920, the rotational control 350 has a lighter color than in stage 910. In some embodiments, the rotational control is a first color (e.g., dark blue) when not receiving user input, and a different second color (e.g., light blue) when receiving user input.

The third stage 930 illustrates the preview display area 310 after moving the rotational control 350 in an arc downwards and to the left (as indicated by the dashed arrow near cursor 900). As shown in stage 930, the shadow projection tool 155 has altered the shape of the drop shadow 940 and the set of on-image controls 300 in several ways. First, the shadow generation tool 155 has recast the shadow at an angle based on the angle between the baseline 360 and the rotational control 350. Second, the shadow generation tool 155 has maintained the drop shadow's 940 shape such that the top of the drop shadow 940 remains in horizontal alignment with the cast line 385. Third, the shadow generation tool 155 has decreased the length of the drop shadow 940 to account for the shorter relative distance between the rotational control 350 and the baseline 360. Fourth, the shadow generation tool 155 has altered the shape of the drop shadow 940 based on the default perspective value because the rotational control has been placed below the baseline 360 (e.g. the triangular portion of the drop shadow 940 is wider on its left side in stage 930 than in stage 920).

In addition, the shadow generation tool 155 has altered the appearance of the frame 365 such that the left edge of the frame 365 is at a left and downward angle, the right edge of the frame 365 is a vertical downward angle, the cast line 385 is below the baseline 360, the blur control 370 is above the baseline 360, and the perspective controls 375 and 380 have been moved farther apart. The overall shape of the frame 365 is trapezoidal in stage 930.

FIG. 10 provides an illustrative example of using the rotational control 350 of the set of on-image controls 300 to rotate a drop shadow 940. Three operational stages 910, 920, and 1030 of the media-editing application are shown in this figure.

The first stage 910 is the same as the one illustrated in FIG. 9. At the first stage 910, the preview display area 310 shows the first media clip 960, the second media clip 950, the drop shadow 940, and the set of on-screen controls 300. The second stage 920 is the same as the one illustrated in FIG. 9. At the second stage 920, the user has selected the rotational control 350 with cursor 900.

The third stage 1030 illustrates the preview display area 310 after moving the rotational control 350 in an arc downwards and to the right (as indicated by the dashed arrow near cursor 900). As shown in stage 1030, the shadow projection tool 155 has altered the shape of the drop shadow 940 and the set of on-image controls 300 in several ways. First, the shadow generation tool 155 has recast the shadow at an angle based on the angle between the baseline 360 and the rotational control 350. Second, the shadow generation tool 155 has maintained the drop shadow's 940 shape such that the top of the drop shadow 940 remains in horizontal alignment with the cast line 385. Third, the shadow generation tool 155 has decreased the length of the drop shadow 940 to account for the shorter relative distance between the rotational control 350 and the baseline 360. Fourth, the shadow generation tool 155 has altered the shape of the drop shadow 940 based on the default perspective value because the rotational control has been placed at a distance above the baseline 360 that is less than the height of the media clip 950 from which the drop shadow 940 was generated (e.g. the triangular portion of the drop shadow 940 is shown with a narrower perspective in stage 1030 than in stage 920).

In addition, the shadow generation tool 155 has altered the appearance of the frame 365 in accordance with the new position of the rotational control 350 such that the left edge of the frame 365 is at right and upward angle, the right edge of the frame 365 is a vertical upward angle, the cast line 385 is above the baseline 360, and the perspective controls 375 and 380 have been moved closer together. The overall shape of the frame 365 is trapezoidal in stage 1030.

F. Example States of a Media-Editing Application

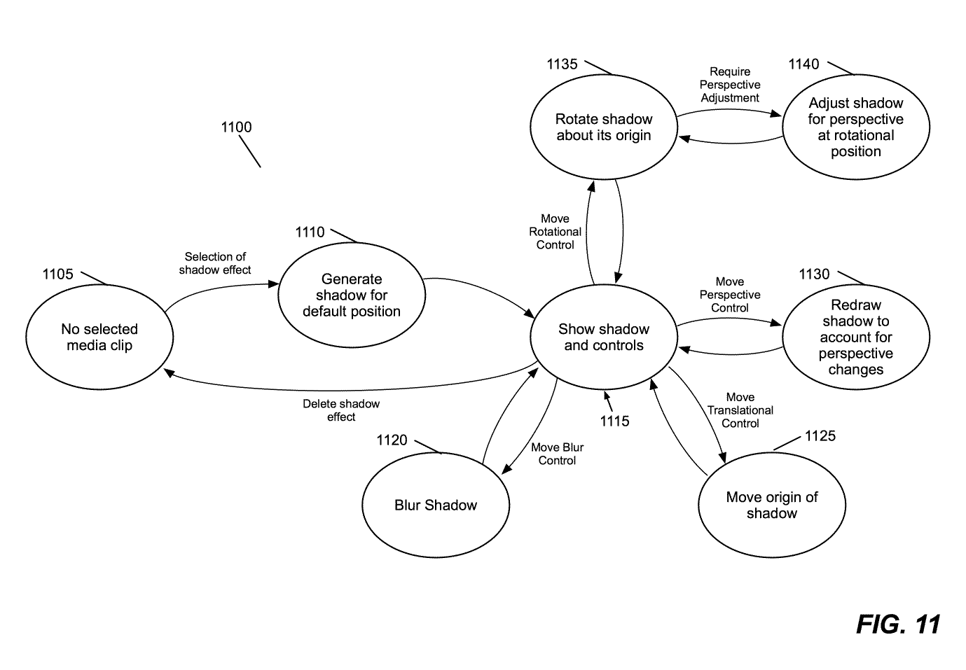

FIG. 11 conceptually illustrates a state diagram of a media-editing application of some embodiments. One of ordinary skill in the art will recognize that the state diagram 1100 does not describe all states of the media-editing application, but instead specifically pertains to several operations that can be performed with the shadow generation tool 155 that is described above by reference to FIGS. 3-9. In some embodiments, each state represents a process that is performed by a particular module associated with the media-editing application.

As shown in FIG. 11, the media-editing application (at 1105) has not generated a shadow for a media clip. At this state 1105, the media-editing application may be performing over tasks, including importing or editing related tasks, organizing, playback operations, etc. In addition, at many of the other states, the application could be performing a wide variety of background tasks (e.g., transcoding, analysis, etc.).

When the shadow effect has been selected (from the effects browser), the media-editing application transitions to state 1110. At this state, the media-editing application generates a shadow for a default position. For example, the media-editing application of some embodiments identifies an object in an image, and then generates a shadow having the same or similar shape. The default position may be the same location as the object in the image. For example, the default position of some embodiments places the shadow in alignment behind the object. Alternatively, the default position may place the shadow behind or in front of the object, and slightly below, above, or to the side of the object.

After the generating the shadow, the media-editing application transitions to state 1115. At this state, the media-editing application shows the shadows, and several controls to modify the attributes of the shadow. In this example, the media-editing application provides (1) a rotational control, (2) a blur control, (3) a perspective control, and (4) a translational control. These controls have been described above by reference to FIG. 3.

When the blur control is moved, the media-editing application transitions to state 1120. Here, the media-editing application changes the blur level of the shadow. An example of changing the blur level has been described above by reference to FIG. 7. After changing the blur level, the media-editing application returns to state 1115.

When the translational control is moved, the media-editing application transitions to state 1125. At this state, the media-editing application moves the origin of the shadow. An example of moving the origin of the shadow has been described above by reference to FIG. 6. After the moving the origin of the shadow, the media-editing application returns to state 1115.

When the perspective control is moved, the media-editing application transitions to state 1130. At this state, the media-editing application redraws shadow to account for perspective changes. An example of such a perspective change is described above by reference to FIG. 8. After redrawing the shadow, the media-editing application returns to state 1115.

When the rotational control is moved, the media-editing application transitions to state 1135. At state 1135, the media-editing application rotates the shadow about its origin. An example of rotating the shadow is described above by reference to FIG. 4 and FIG. 5. After rotating the shadow, the media-editing application returns to state 1115. However, if the perspective has been adjusted, the media-editing application transitions to state 1140. At state 1140, the media-editing application adjusts the shadow for perspective at the rotational position. Several examples of such adjustment are described above by reference to FIG. 9 and FIG. 10. Lastly, when the shadow is deleted, the media-editing application returns to state 1105, which is described above.

The set of on-image controls provided by the media-editing application allows for substantial control over a drop shadow. Other embodiments of the invention provide alternative means of controlling a drop shadow. In the embodiments discussed below, the media-editing application provides an inspector panel with a series of slider and drop down controls with numerical feedback for fine control of the drop shadow.

### III. Shadow Inspector Tools

As mentioned above, the shadow generation tool of some embodiments provides user interface items to modify attributes (e.g., sliders, input fields) of a shadow. In some embodiments, the media-editing application includes a display area (also referred to as an inspector panel) that lists the attributes of a shadow and several user interface items to modify those attributes.

A. Inspector Display Area

FIG. 12 provides an illustrative example of an inspector panel 1200 for modifying attributes of a shadow. The media-editing application includes the preview display 310 and the inspector panel 1200. The preview display area is the same as the one described above by reference to FIG. 3.

In some embodiments, the inspector panel 1200 displays detailed properties about a selected item and allows a user to modify some or all of these properties. The selected item might be a clip, a composite presentation, an effect, etc. In the example illustrated in FIG. 12, the shadow object or effect has been selected, and thus the inspector displays information about the shadow. The information includes color, opacity, selected preset, blur, blur falloff, shadow position, perspective point position, and perspective amount. To modify these properties, the inspector panel 1200 provides a set of inspector controls 1210.

The set of controls 1210 includes a color dropdown menu 1220, an opacity slider 1230, a presets dropdown menu 1240, a blur slider 1250, a blur falloff slider 1260, a shadow position control 1270, a perspective point position control 1280, and a perspective slider 1290. Each control displays a numerical value for the corresponding attribute associated with the drop shadow 340. When a property of an attribute has been changed with any one of these controls, the media-editing application modifies the appearance of the drop shadow 340 in accordance with said change.

The color dropdown menu 1220 (also referred to as a color picker) allows the user to select a color for the drop shadow 340. In the example of FIG. 12, the color dropdown menu 1220 shows that the drop shadow's color attribute is black. Consistent with the color dropdown menu 1220, the drop shadow 340 is displayed as black in the preview display area 310. The color dropdown menu 1220 can provide numerous possible colors for the drop shadow 340.

The opacity slider 1230 controls the opacity attribute associated with the drop shadow 340. In some embodiments, the opacity attribute defines how transparent the shadow appears in the scene. As shown in FIG. 12, the drop shadow's opacity attribute is set at 75%. Consistent with an opacity value of 75%, the drop shadow 340 is displayed with mostly solid opacity in the preview display area 310.

The dropdown menu 1240 provides a set of preset configurations that can be selected for the drop shadow 340. As shown in FIG. 12, the drop shadow 340 has a “Default” preset configuration with a color of black, an opacity of 75%, a blur of 10%, a blur falloff of 10%, an origin position of X=0.5 px and Y=−0.6 px, a perspective point position of X=0.0 px and Y=0.5 px, and a perspective amount of 0.0. One of ordinary skill in the art would understand that these are just example values that can be modified in a number of different ways. For example, the origin and perspective point values can be expressed differently using different units or measurements such as a per pixel unit.

Consistent with the previously listed attributes, drop shadow 340 is shown with modest blurring, no perspective effects, and displaced slightly downwards and to the right of media clip 330. In some embodiments, a user can select a “Perspective Front” preset that results in the drop shadow projected in a wide shape in front of the media clip from which it was generated. The “Perspective Front” preset configuration has a color of black, an opacity of 100%, a blur of 100%, a blur falloff of 0%, an origin position of X=0.0 px and Y=−0.5 px, a perspective point position of X=0.0 px and Y=−1.0 px, and a perspective amount of 1.0. As mentioned above, these attribute values are just example values that can be modified using different units or measurements. In some embodiments, the media editing application provides other presets (e.g., “Classic Drop Shadow”, “Perspective Back”) and/or allow its users to create custom presets.

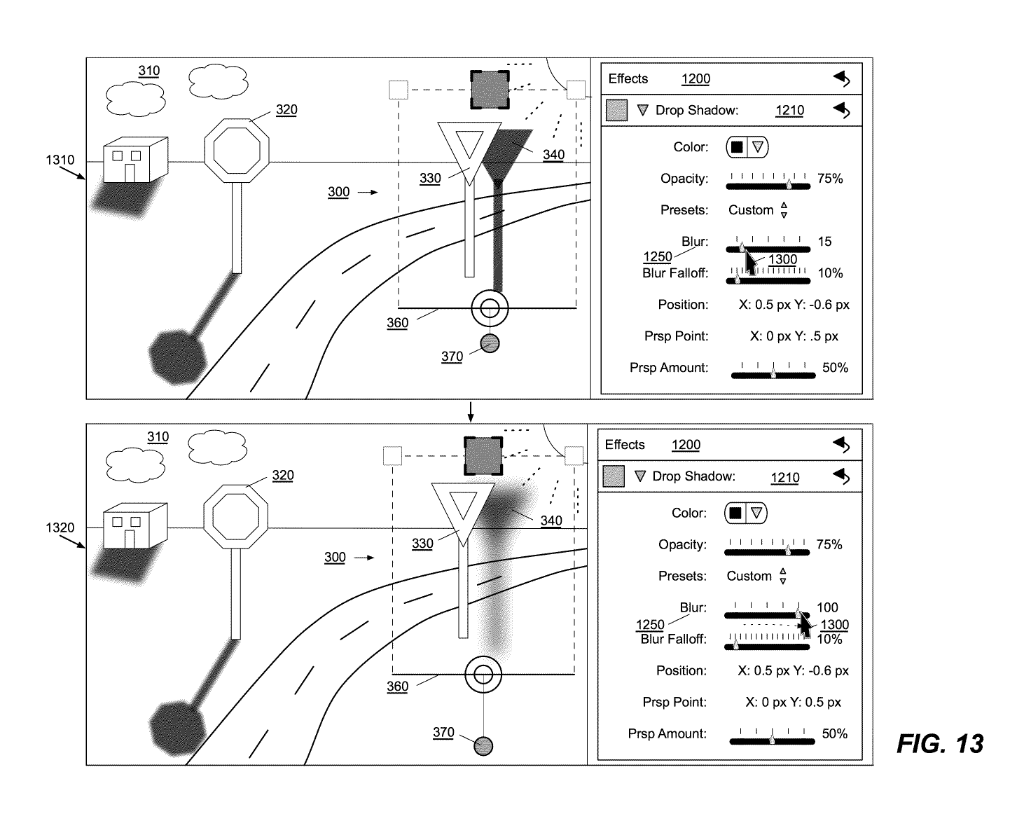

The blur slider 1250 controls the blur attribute associated with the drop shadow 340. The blur attribute in some embodiments defines how blurry the shadow appears in the scene. In the example of FIG. 12, the blur slider 1250 shows that the drop shadow's blur level is at 10%. Consistent with the blur slider 1250, the drop shadow 340 is displayed with only mild blurring over the background image of the first media clip 320 in the preview display area 310. The effect of manipulating the blur slider 1250 will be discussed in greater detail below by reference to FIG. 13.

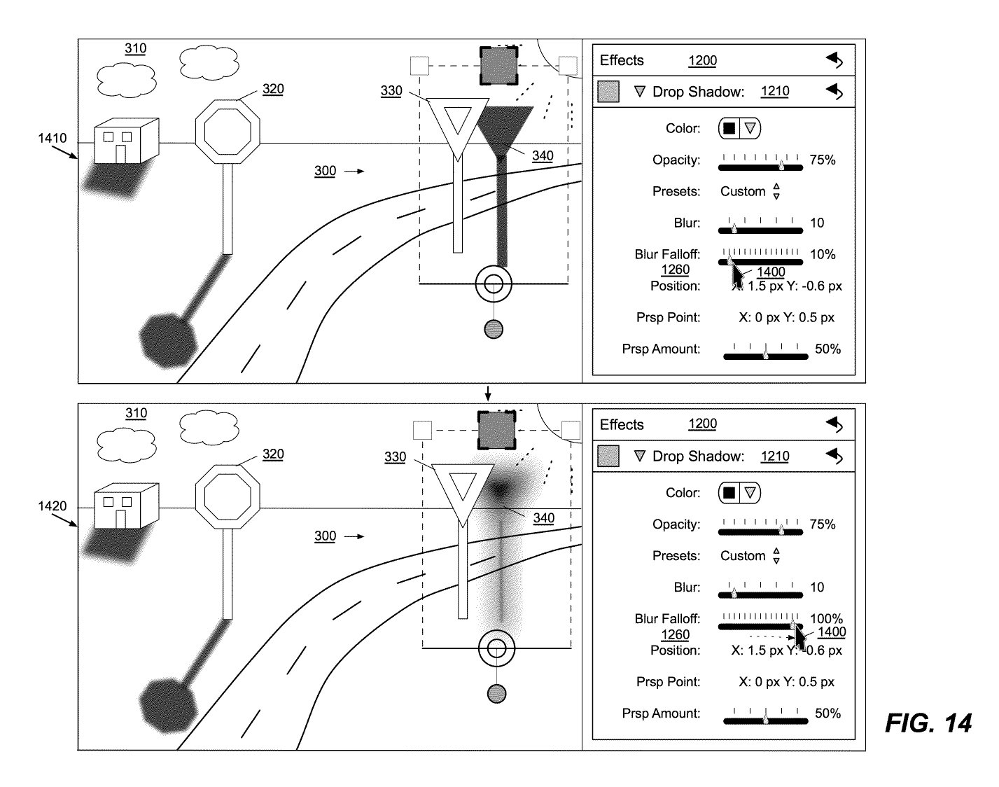

The blur falloff slider 1260 controls the blur falloff attribute associated with the drop shadow. In some embodiments, the blur falloff attribute defines the extent to which the blurring of the shadow increases between the center of the shadow and its edges (e.g. higher blur falloff results in heavily blurred, barely visible edges of a shadow whereas lower blur falloff results in a consistent blurring between the center and the edges of a shadow). In the example of FIG. 12, the blur falloff slider 1260 shows that the drop shadow's blur falloff level is at 10%. Consistent with a blur falloff level of 10%, the drop shadow 340 is displayed with only mild blur falloff (i.e., the shadow remains relatively solid from its center to its edges) in the preview display area 310. The effects of manipulating the blur falloff slider 1260 will be discussed in greater detail below in conjunction with FIG. 14.

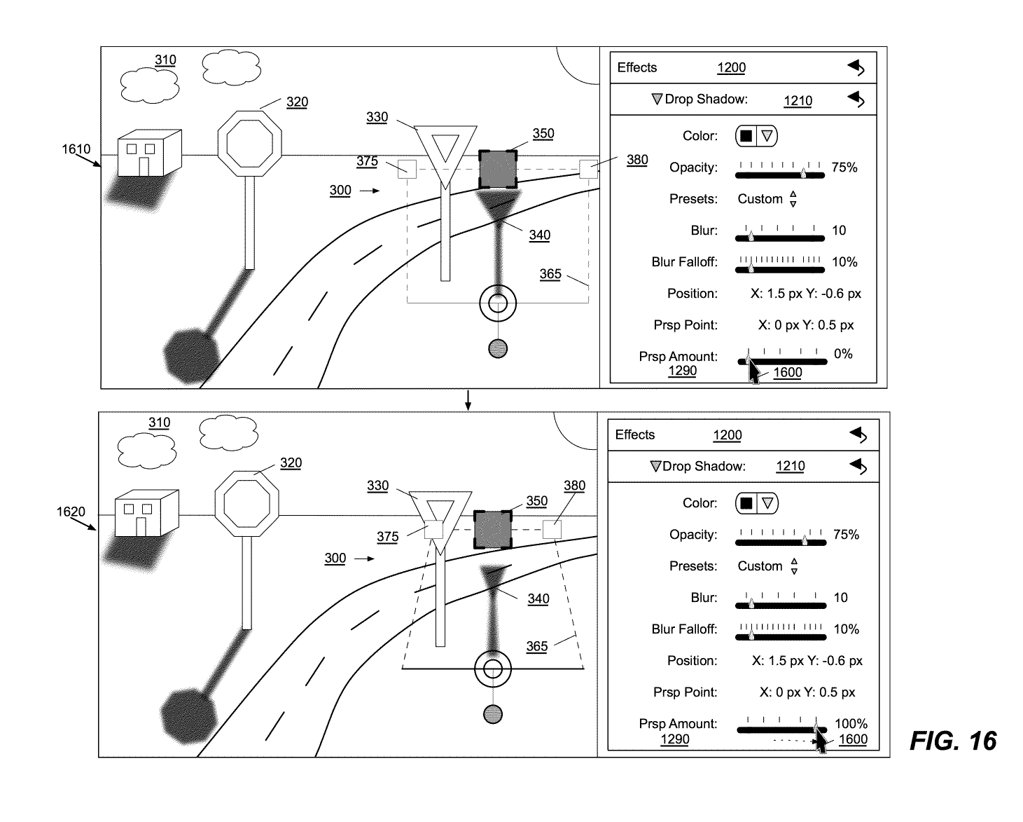

The shadow position control 1270 can be used to reposition the origin of a drop shadow. Here, the shadow position control is associated with several input fields to specify the position of the origin of a shadow. As shown in FIG. 12, the position control shows that the drop shadow's origin position is at X=0.5 px and Y=−0.6 px, “X” is the horizontal offset of the origin of the drop shadow 340 from the center of the second media clip 330. In some embodiments, positive “X” values indicate that the origin of the drop shadow is to the right of the media clip from which it has been generated in the preview display. Conversely, negative “X” values indicate that the origin of the drop shadow is to the left of the media clip from which it has been generated in the preview display area. “Y” is the vertical offset of the origin of the origin of the drop shadow 340 from the center of the second media clip 330. In some embodiments, positive “Y” values indicate that the origin of the drop shadow is above of the center of the media clip from which it has been generated in the preview display. Conversely, negative “Y” values indicate that the origin of the drop shadow is below the center media clip from which it has been generated in the preview display. In some embodiments, “px” is a unit of measurement within the preview display. In some embodiments, “px” is based on the size of the media clip from which the drop shadow was generated. In some embodiments, the “px” represents pixels, and is based on the number of pixels over a given distance. Consistent with shadow position values X=0.5 px and Y=−0.6 px, the drop shadow 340 is slightly to the right and downwards from the media clip 330 in preview display area 310. In some embodiments, the unit of measurement “px” measures a number of pixels traversed over a given distance in an image. Accordingly, the position values may be expressed differently than the example shown in FIG. 16.

The perspective position control 1280 can be used to modify the rotation properties associated with the drop shadow 340. In some embodiments, the control 1280 is associated with the location of the rotational control 350. For example, the perspective position control 1280 shows that the rotational control's position is at X 0.0 px and Y=0.5 px, “X” is the horizontal offset of the rotational control 350 associated with the drop shadow 340 from the midpoint of the baseline 360. Positive “X” values indicate that the drop shadow is to the right of the midpoint of the baseline 360. Negative “X” values indicate that the drop shadow is to the left of the midpoint of the baseline 360. “Y” is the vertical offset of the rotational control 350 from the center point of the image that contains the shadow. Positive “Y” values indicate that the rotational control 350 is above the center point of the image that contains the shadow. Negative “Y” values indicate that the drop shadow is below the image that contains the shadow. Consistent with perspective position values X=0.0 px and Y=0.5 px, the rotational control 350 is in vertical alignment midpoint of the baseline 360 and approximately half the media clip's height above the center of the image that contains the drop shadow 340.

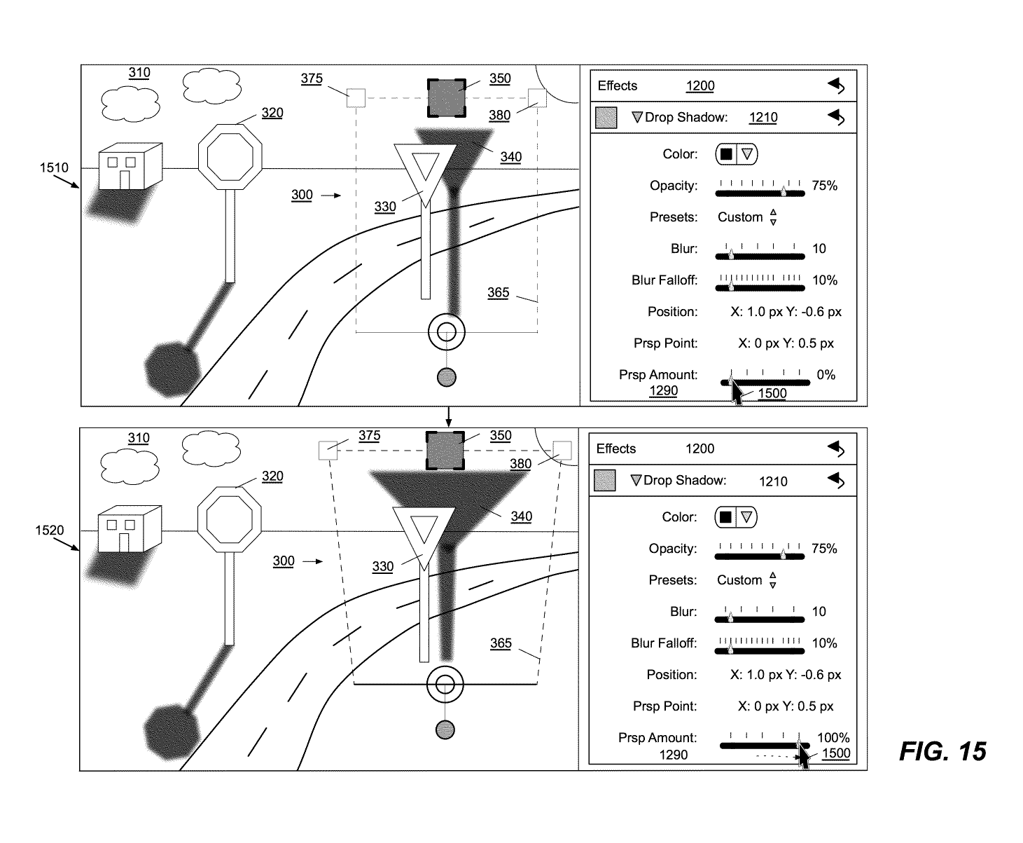

The perspective slider 1290 controls the perspective value associated with the drop shadow. Perspective values of some embodiments range from 0.0 to 1.0. The effect of the perspective value depends on the location of the rotational control relative to the baseline. When the rotational control is placed at a distance above the baseline that is greater than the height of the media clip from which the drop shadow was generated, a non-zero perspective value (e.g. 0.75) results in a drop shadow that appears wider. When the rotational control is placed at a distance above the baseline that is less than the height of the media clip from which the drop shadow was generated, a non-zero perspective value results in a drop shadow that appears narrower and cast farther away from the viewer. When the rotational control is placed below the baseline, a non-zero perspective value results in a drop shadow that appears wider and cast closer to the viewer. Lower perspective values (e.g. 0.1) result in less widening or narrowing effects. The perspective slider 1290 shows that the drop shadow's 340 perspective value is at 0.0. Consistent with a perspective value of 0.0, the drop shadow 340 is displayed with neither a wider nor a narrower perspective than the second media clip 330 in the preview display area 310. The effects of manipulating the perspective slider 1290 will be discussed in greater detail below in conjunction with FIG. 15 and FIG. 16.

B. Modifying Blur Attribute

FIG. 13 illustrates the use of the blur slider 1250 of the set of inspector controls 1210 to change the blurring of drop shadow 340 with the first media clip 320 over two stages 1310 and 1320. Stages 1310 and 1320 conceptually illustrate the preview display area 310 at first and second periods, respectively. For purposes of illustration, the drop shadow 340 is illustrated darker in stage 1310 in order to make the blur effect clearer for the reader.

At the first stage 1310, the blur slider 1250 shows that the drop shadow's blur level is at 15. In some embodiments, the blue level is expressed in terms of pixels (i.e., 15 pixels), and the blur level falloff is expressed in terms of a percentage. Consistent with the blur level indicated by the blur slider 1250, the drop shadow 340 is displayed with only mild blurring with the background image of the first media clip 320 in the preview display area 310.

In the first stage 1310, the user selects a knob associated with slider 1250. The second stage 1320 illustrates the media-editing application after the knob has been moved to modify the blur attribute. Specifically, the user has dragged the knob of blur slider 1250 to the right (as indicated by the dashed arrow near cursor 1300) and the blur slider 1250 shows that the drop shadow's blur level is at 100 pixels.

As shown in stage 1320, the adjustment of the blur attribute has caused the drop shadow to appear significantly blurrier than in stage 1310. The adjustment to the blur attribute has also caused the blur control point 370 to be modified. Specifically, the blur control has been moved further away from the shadow (e.g., from the frame's lower edge or baseline 360) to match the new blur level.

C. Modifying Blur Falloff Attribute

FIG. 14 illustrates the use of the blur falloff slider 1260 of the set of inspector controls 1210 to change the blur falloff of drop shadow 340 over two stages 1410 and 1420. Stages 1410 and 1420 conceptually illustrate the preview display area 310 at first and second periods, respectively. For purposes of illustration, the drop shadow 340 is illustrated darker in stage 1410 in order to make the blur falloff effect clearer for the reader.

At the first stage 1410, the blur falloff slider 1260 shows that the drop shadow's blur falloff level is at 10%. Consistent with the blur falloff value indicated by the blur falloff slider 1260, the drop shadow 340 is displayed with only mild blur falloff (i.e., the shadow remains relatively solid from its center to its edges) in the preview display area 310.

In the first stage 1410, the user selects a knob associated with falloff slider 1260. The second stage 1420 illustrates the media-editing application after the knob has been moved to modify the blur falloff attribute. Specifically, the user has dragged the knob of blur falloff slider 1260 to the right (as indicated by the dashed arrow near cursor 1400).

The blur falloff attribute value has been changed from 10% to 100%. As such, in stage 1420, the drop shadow 340 has significantly higher blur falloff (e.g., the drop shadow 340 appears significantly blurrier at its edges than its center in stage 1420).

D. Modifying Perspective Value

FIG. 15 illustrates the use of the perspective slider 1290 of the set of inspector controls 1210 to change the perspective of drop shadow 340 over two stages 1510 and 1520. Stages 1510 and 1520 conceptually illustrate the preview display area 310 at first and second times, respectively.

At the first stage 1510, the perspective slider 1290 shows that the drop shadow's perspective level is at 0.0 or 0%. Consistent with the perspective level indicted by the perspective slider 1290, the drop shadow 340 is displayed with neither a wider nor a narrower perspective than the second media clip 330 in the preview display area 310.

In the first stage 1510, the user selects a knob associated with the perspective slider 1290. The second stage 1520 illustrates the media-editing application after the knob has been moved to modify the perspective value. Specifically, the user has dragged the knob of perspective slider 1290 to the right (as indicated by the dashed arrow near cursor 1500). The perspective slider 1290 shows that the drop shadow's perspective level is at 1.0 or 100%.

As shown in stage 1520, the shadow generation tool 155 has rendered drop shadow 340 with a significantly wider perspective than in stage 1510 because the rotational control 350 is placed at a distance above the baseline that is greater than the height of the media clip 330 from which the drop shadow 340 was generated. Specifically, the triangular portion of the drop shadow 340 is relatively wider than the stem portion of the drop shadow 340. Here, the frame 365 now has a wider trapezoidal shape proportional to the modifications made to the drop shadow 340. As shown in stage 1520, the shadow generation tool 155 has moved the perspective controls 375 and 380 outwards to match the new perspective.

FIG. 16 illustrates the use of the perspective slider 1290 of the set of inspector controls 1210 to change the perspective of drop shadow 340 over two stages 1610 and 1620. Stages 1610 and 1620 conceptually illustrate the preview display area 310 at first and second times, respectively.

At the first stage 1610, the perspective slider 1290 shows that the drop shadow's perspective level is at 0.0 or 0%. Consistent with the perspective slider 1290, the drop shadow 340 is displayed with neither a wider nor a narrower perspective than the second media clip 330 in the preview display area 310.

In the first stage 1610, the user selects a knob associated with perspective slider 1290. The second stage 1620 illustrates the media-editing application after the knob has been moved to modify the perspective value. Specifically, the user has dragged the knob of perspective slider 1290 to the right (as indicated by the dashed arrow near cursor 1600). The perspective slider 1290 shows that the drop shadow's perspective level is at 1.0 or 100%. As shown in stage 1620, the shadow generation tool 155 has rendered drop shadow 340 with a significantly narrower perspective than in stage 1610 because the rotational control 350 is placed at a distance above the baseline that is less than the height of the media clip 330 from which the drop shadow 340 was generated. Specifically, the triangular portion of the drop shadow 340 is relatively narrower than the stem portion of the drop shadow 340. As shown in stage 1620, frame 365 now has a narrowed trapezoidal shape proportional to the modifications made to the drop shadow 340. As shown in stage 1620, the shadow generation tool 155 has moved the perspective controls 375 and 380 inwards to match the new perspective.

The set of inspector controls 1210 in the inspector panel 1200 allows for fine control over the drop shadow 340 and the shadow generation tool 155. Other embodiments of the invention provide a wider range of controls within a media-editing application. In the embodiments discussed below, the shadow generation tool 155, set of on-screen controls 300, and inspector panel 1200 will be discussed in the context of a media-editing application.

### IV. Example Media Editing Application

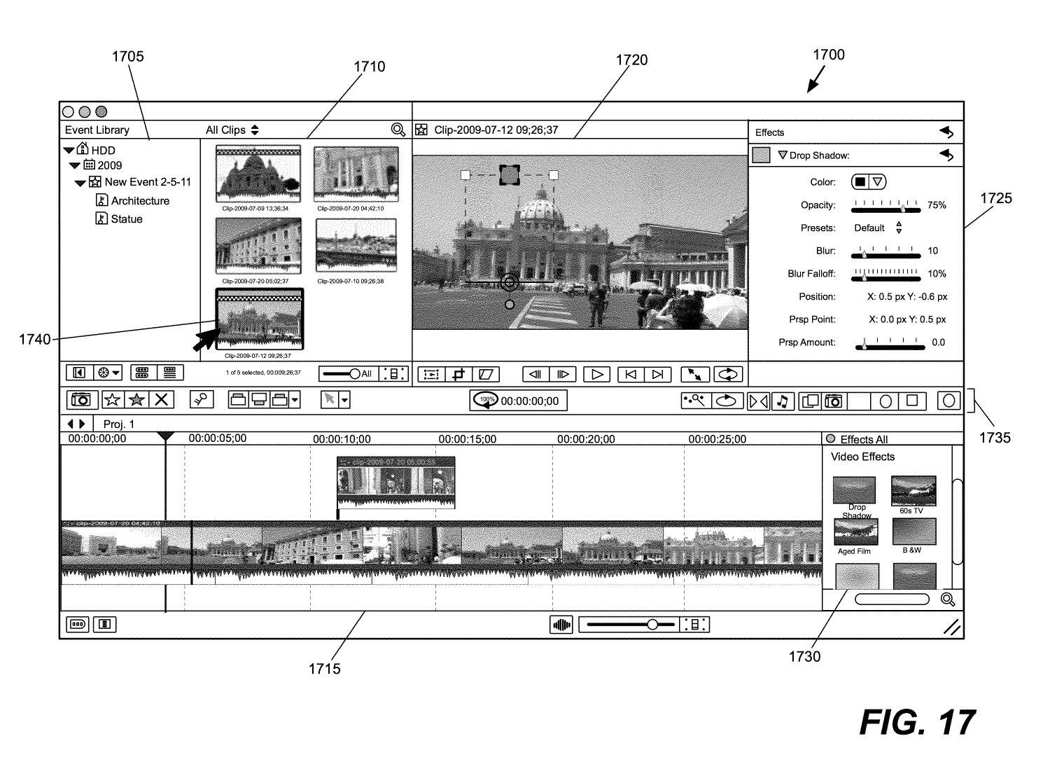

FIG. 17 illustrates a graphical user interface (GUI) 1700 of a media-editing application of some embodiments. One of ordinary skill in the art will recognize that the graphical user interface 1700 is only one of many possible GUIs for such a media-editing application. In fact, the GUI 1700 includes several display areas, which may be adjusted in size, opened or closed, replaced with other display areas, etc. The GUI 1700 includes a clip library 1705 (also referred to as an event library), a clip browser 1710 (also referred to as an event browser), a timeline 1715, a preview display area 1720, an inspector display area 1725, an additional media display area 1730, and a toolbar 1735.

The clip library 1705 includes a set of folder-like or bin-line representations through which a user accesses media clips that have been imported into the media-editing application. Some embodiments organize the media clips according to the device (e.g., physical storage device such as an internal or external hard drive, virtual storage device such as a hard drive partition, etc.) on which the media represented by the clips are stored. Some embodiments also enable the user to organize the media clips based on the date the media represented by the clips was created (e.g., recorded by a camera).

Within a storage device and/or date, users may group the media clips into “events”, or organized folders of media clips. For instance, a user might give the events descriptive names that indicate what kind of media is stored in the event (e.g., the “New Event 2-5-11” event shown in clip library 1705 might be renamed “European Vacation” as a descriptor of the content). In some embodiments, the media files corresponding to these clips are stored in a file storage structure that mirrors the folders shown in the clip library.

The clip browser 1710 allows the user to view clips from a selected folder or collection (e.g., an event, a sub-folder, etc.) of the clip library 1705. In the example of FIG. 17, the collection “New Event 2-5-11” is selected in the clip library 1705, and the clips belonging to that folder are displayed in the clip browser 1710. Some embodiments display the clips as thumbnail filmstrips, as shown in this example. By moving a cursor (or a finger on a touchscreen) over one of the thumbnails (e.g., with a mouse, a touchpad, a touchscreen, etc.), the user can skim through the clip. That is, when the user places the cursor at a particular horizontal location within the thumbnail filmstrip, the media-editing application associates that horizontal location with a time in the associated media file, and displays the image from the media file for that time. In addition, the user can command the application to play back the media file in the thumbnail filmstrip.

In addition, the thumbnails for the clips in the browser display an audio waveform underneath the clip that represents the audio of the media file. In some embodiments, as a user skims through or plays back the thumbnail filmstrip, the audio plays as well. Many of the features of the clip browser are user-modifiable. For instance, in some embodiments, the user can modify one or more of the thumbnail size, the percentage of the thumbnail occupied by the audio waveform, whether audio plays back when the user skims through the media files, etc.

In addition, some embodiments enable the user to view the clips in the clip browser 1710 in a list view. In this view, the clips are presented as a list (e.g., with clip name, duration, etc.). Some embodiments also display a selected clip from the list in a filmstrip view at the top of the clip browser 1710 so that the user can skim through or playback the selected clip. The list view in some embodiments allows users to select different ranges of a media clip and/or navigate to different sections of the media clip.

The timeline 1715 provides a visual representation of a composite presentation (or project) being created by the user of the media-editing application. Specifically, it displays one or more geometric shapes that represent one or more media clips that are part of the composite presentation. The timeline 1715 of some embodiments includes a primary lane (also called a “spine”, “primary compositing lane”, or “central compositing lane”) as well as one or more secondary lanes (also called “anchor lanes”). The spine represents a primary sequence of media, which, in some embodiments, does not have any gaps. The clips in the anchor lanes are anchored to a particular position along the spine (or along a different anchor lane). Anchor lanes may be used for compositing (e.g., removing portions of one video and showing a different video in those portions), B-roll cuts (i.e., cutting away from the primary video to a different video whose clip is in the anchor lane), or other composite presentation techniques.

The user can select media clips from the clip browser 1710 into the timeline 1715 in order to add the clips to a presentation represented in the timeline. Within the timeline, the user can perform further edits to the media clips (e.g., move the clips around, split the clips, trim the clips, apply effects to the clips, etc.). The length (i.e., horizontal expanse) of a clip in the timeline is a function of the length of the media represented by the clip. As the timeline is broken into increments of time, a media clip occupies a particular length of time in the timeline. As shown, in some embodiments the clips within the timeline are shown as a series of images. The number of images displayed for a clip varies depending on the length of the clip in the timeline, as well as the size of the clips (as the aspect ratio of each image will stay constant).

As with the clips in the clip browser, the user can skim through the timeline or play back the timeline (either a portion of the timeline or the entire timeline). In some embodiments, the playback (or skimming) is not shown in the timeline clips, but rather in the preview display area 1720.

The preview display area 1720 (also referred to as a “viewer”) displays images from media files, which the user is skimming through, playing back, or editing. These images may be from a composite presentation in the timeline 1715 or from a media clip in the clip browser 1710. In this example, the user has been skimming through the beginning of clip 1740, and therefore an image from the start of this media file is displayed in the preview display area 1720. As shown, some embodiments will display the images as large as possible within the display area while maintaining the aspect ratio of the image.

The inspector display area 1725 (also referred to as an “inspector panel”) displays detailed properties about a selected item and allows a user to modify some or all of these properties. The selected item might be a clip, a composite presentation, an effect, etc. In this case, the clip that is shown in the preview display area 1720 is also selected, and thus the inspector displays information about a drop associated with media clip 1740. This information about the drop shadow was discussed above by reference to FIG. 12. In some embodiments, different information is displayed depending on the type of item selected.

The additional media display area 1730 displays various types of additional media, such as video effects, transitions, still images, titles, audio effects, standard audio clips, etc. In some embodiments, the set of effects is represented by a set of selectable UI items, in which each selectable UI item represents a particular effect. As shown in FIG. 17, the additional media display area 1730 is currently showing the effects browser described above in reference to FIG. 1. In some embodiments, each selectable UI item also includes a thumbnail image with the particular effect applied. The display area 1730 is currently displaying a set of effects for the user to apply to a clip. In the embodiment shown in FIG. 17, the drop shadow effect is available for selection in the display area 1730.

The toolbar 1735 includes various selectable items for editing, modifying items that are displayed in one or more display areas, etc. The toolbar 1735 includes various selectable items for modifying the type of media that is displayed in the additional media display area 1730. The illustrated toolbar 1735 includes items for video effects, visual transitions between media clips, photos, titles, generators and backgrounds, etc. In addition, the toolbar 1735 includes a selectable inspector item that causes the display of the inspector display area 1725 as well as items for applying a retiring operation to a portion of the timeline, adjusting color, and other functions. The toolbar 1735 also includes selectable items for media management and editing. Selectable items are provided for adding clips from the clip browser 1710 to the timeline 1715. In some embodiments, different selectable items may be used to add a clip to the end of the spine, add a clip at a selected point in the spine (e.g., at the location of a playhead), add an anchored clip at the selected point, perform various trim operations on the media clips in the timeline, etc. The media management tools of some embodiments allow a user to mark selected clips as favorites, among other options.

One of ordinary skill in the art will also recognize that the set of display areas shown in the GUI 1700 is one of many possible configurations for the GUI of some embodiments. For instance, in some embodiments, the presence or absence of many of the display areas can be toggled through the GUI (e.g., the inspector display area 1725, additional media display area 1730, and clip library 1705). In addition, some embodiments allow the user to modify the size of the various display areas within the UI. For instance, when the additional display area 1730 is removed, the timeline 1715 can increase in size to include that area. Similarly, the preview display area 1720 increases in size when the inspector display area 1725 is removed.

### V. Software Architecture

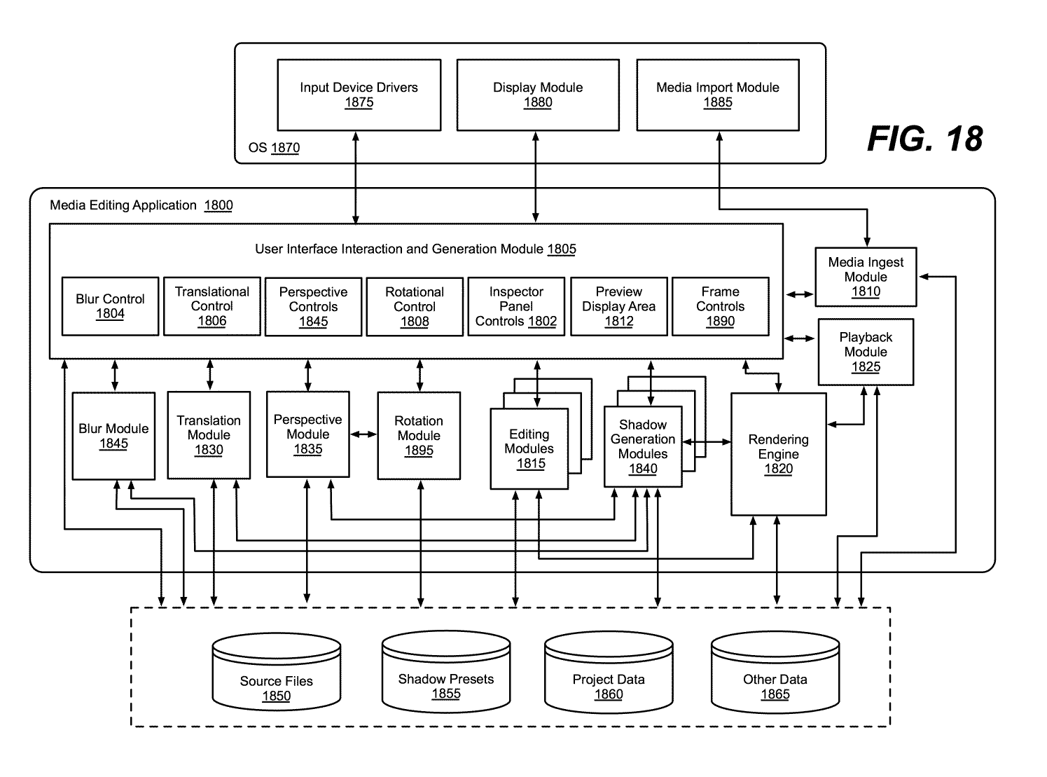

In some embodiments, the processes described above are implemented as software running on a particular machine, such as a computer or a handheld device, or stored in a machine readable medium. FIG. 18 conceptually illustrates the software architecture of a media editing application 1800 of some embodiments. In some embodiments, the media editing application is a stand-alone application or is integrated into another application, while in other embodiments the application might be implemented within an operating system. Furthermore, in some embodiments, the application is provided as part of a server-based solution. In some such embodiments, the application is provided via a thin client. That is, the application runs on a server while a user interacts with the application via a separate machine remote from the server. In other such embodiments, the application is provided via a thick client. That is, the application is distributed from the server to the client machine and runs on the client machine.

The media editing application 1800 includes a user interface (UI) interaction and generation module 1805, a media ingest module 1810, editing modules 1815, a rendering engine 1820, a playback module 1825, shadow generation modules 1840, a perspective maintenance module 1835, a translation module 1830, a blur module 1845, and a rotation module 1895. As shown, the user interface interaction and generation module 1805 generates a number of different UI elements, including a translational control 1806, perspective controls 1845, a blur control 1804, a rotational control 1808, inspector panel controls 1802, a preview display area 1812, and frame controls 1890.

The figure also illustrates stored data associated with the media-editing application: source files 1850, shadow presets 1855, project data 1860, and other data 1865. In some embodiments, the source files 1850 store media files (e.g., video files, still images, combined video and image files, etc.) imported into the application. The source files 1850 of some embodiments also store transcoded versions of the imported files as well as analysis data (e.g., people detection data, shake detection data, color balance data, etc.). The shadow presets 1855 stores preset configurations that can be selected for drop shadows in the inspector panel controls 1802. The shadow presets 1855 may be stored as one or more SQLite database (or other format) files in some embodiments. The project data 1860 stores the project information used by some embodiments to specify a composite presentation. The project data 1860 may also be a set of clip object data structures stored as one or more SQLite database (or other format) files in some embodiments.

In some embodiments, the four sets of data 1850, 1855, 1860, and 1865 are stored in a single physical storage (e.g., an internal hard drive, external hard drive, etc.). In some embodiments, the data may be split between multiple physical storages. For instance, the source files might be stored on an external hard drive with the event data, project data, and other data on an internal drive. Some embodiments store event data with their associated source files and render files in one set of folders, and the project data with associated render files in a separate set of folders.

FIG. 18 also illustrates an operating system 1870 that includes input device driver(s) 1875, display module 1880, and media import module 1885. In some embodiments, as illustrated, the device drivers 1875, display module 1880, and media import module 1885 are part of the operating system 1870 even when the media editing application 1800 is an application separate from the operating system 1870.

The input device drivers 1875 may include drivers for translating signals from a keyboard, mouse, touchpad, tablet, touchscreen, etc. A user interacts with one or more of these input devices, each of which send signals to its corresponding device driver. The device driver then translates the signals into user input data that is provided to the UI interaction and generation module 1805.

The present application describes a graphical user interface that provides users with numerous ways to perform different sets of operations and functionalities. In some embodiments, these operations and functionalities are performed based on different commands that are received from users through different input devices (e.g., keyboard, trackpad, touchpad, mouse, etc.). For example, the present application illustrates the use of a cursor in the graphical user interface to control (e.g., select, move) objects in the graphical user interface. However, in some embodiments, objects in the graphical user interface can also be controlled or manipulated through other controls, such as touch control. In some embodiments, touch control is implemented through an input device that can detect the presence and location of touch on a display of the device. An example of such a device is a touch screen device. In some embodiments, with touch control, a user can directly manipulate objects by interacting with the graphical user interface that is displayed on the display of the touch screen device. For instance, a user can select a particular object in the graphical user interface by simply touching that particular object on the display of the touch screen device. As such, when touch control is utilized, a cursor may not even be provided for enabling selection of an object of a graphical user interface in some embodiments. However, when a cursor is provided in a graphical user interface, touch control can be used to control the cursor in some embodiments.

The display module 1880 translates the output of a user interface for a display device. That is, the display module 1880 receives signals (e.g., from the UI interaction and generation module 1805) describing what should be displayed and translates these signals into pixel information that is sent to the display device. The display device may be an LCD, plasma screen, CRT monitor, touchscreen, etc.

The media import module 1885 receives media files (e.g., image files, video files, etc.) from storage devices (e.g., external drives, recording devices, etc.) through one or more ports (e.g., a USB port, Firewire port, etc.) of the device on which the application 1800 operates and translates this media data for the media-editing application or stores the data directly onto a storage of the device.

The UI interaction and generation module 1805 of the media editing application 1800 interprets the user input data received from the input device drivers 1875 and passes it to various modules, including the rotation module 1895, the editing modules 1815, the rendering engine 1820, the playback module 1825, the shadow generation modules 1840, the perspective maintenance module 1835, the blur module 1845, and the translation module 1830. The UI interaction and generation module 1805 also manages the display of the UI, and outputs this display information to the display module 1880. This UI display information may be based on information from the editing modules 1815, the playback module 1825, and the four sets of data 1850, 1855, 1860, and 1865. In some embodiments, the UI interaction and generation module 1805 generates a basic GUI and populates the GUI with information from the other modules and stored data.

As shown, the UI interaction and generation module 1805, in some embodiments, generates a number of different UI elements. These elements, in some embodiments, include the translational control 1806, the perspective controls 1845, the blur control 1804, the rotational control 1808, the inspector panel controls 1802, the preview display area 1812, and the frame controls 1890. All of these UI elements are described in many different examples above. For example, several operations performed with the rotational control 1808 are described above by reference to FIG. 4, FIG. 5, FIG. 9, and FIG. 10. Several example operations performed with the inspector panel controls 1802 are described above by reference to FIGS. 12-16. Also, several example operations performed with the set of analysis/import tools 1890 are described above by reference to FIG. 1. In addition, several example operations performed with the perspective controls 1845 are described above by reference to FIG. 8. In addition, several example operations performed with the blur control 1804 are described above by reference to FIG. 7. Further, several example operations performed with the translational control 1806 are described above by reference to FIG. 6. As mentioned, the media editing application, in some embodiments, maintains a database of previous user input or interactions to provide an auto-complete feature. The media editing application, in some embodiments, maintains a list of common production and/or editing terms. In some embodiments, these data items are stored in the storage 1865.

The media ingest module 1810 manages the import of source media into the media-editing application 1800. Some embodiments, as shown, receive source media from the media import module 1885 of the operating system 1870. The media ingest module 1810 receives instructions through the UI interaction and generation module 1805 as to which files should be imported, then instructs the media import module 1885 to enable this import (e.g., from an external drive, from a camera, etc.). The media ingest module 1810 stores these source files 1850 in specific file folders associated with the application. In some embodiments, the media ingest module 1810 also manages the creation of event data structures upon import of source files and the creation of the clip and asset data structures contained in the events.

The editing modules 1815 include a variety of modules for editing media in the clip browser as well as in the timeline. The editing modules 1815 handle the creation of projects, addition and subtraction of clips from projects, trimming or other editing processes within the timeline, application of effects and transitions, or other editing processes. In some embodiments, the editing modules 1815 create and modify project and clip data structures in the project data 1860.

The rendering engine 1820 handles the rendering of images for the media-editing application. In some embodiments, the rendering engine 1820 manages the creation of images for the media-editing application. When an image is requested by a destination within the application (e.g., the playback module 1825) the rendering engine 1820 outputs the requested image according to the project or event data. The rendering engine 1820 retrieves the project data or event data that identifies how to create the requested image and generates a render graph that is a series of nodes indicating either images to retrieve from the source files or operations to perform on the source files. In some embodiments, the rendering engine 1820 schedules the retrieval of the necessary images through disk read operations and the decoding of those images.

In some embodiments, the render engine 1820 performs various operations to generate an output image. In some embodiments, these operations include blend operations, effects (e.g., blur or other pixel value modification operations), color space conversions, resolution transforms, etc. In some embodiments, one or more of these processing operations are actually part of the operating system and are performed by a GPU or CPU of the device on which the application 1800 operates. The output of the rendering engine (a rendered image) may be stored as render files in storage 1865 or sent to a destination for additional processing or output (e.g., playback).

The playback module 1825 handles the playback of images (e.g., in a preview display area 1812 of the user interface). Some embodiments do not include a playback module and the rendering engine directly outputs its images for integration into the GUI, or directly to the display module 1880 for display at a particular portion of the display device.

The shadow generation modules 1840 generate shadows from media clips. As shown, the shadow generation modules 1840, in some embodiments, utilize the rendering engine 1820 to create copies of shadows generated from media clips. In some embodiments, the shadow generation modules 1840 operate in conjunction with the perspective maintenance module 1835 to redraw shadows as their perspectives are modified. For example, the shadow generation modules 1840 may receive perspective values from the perspective maintenance module 1835 to use in redrawing shadows.

In some embodiments, the translation module 1830 modifies the origin positions of shadows. The translation module 1830 modifies origin positions of shadows in response to input to the translational control 1806 and the frame controls 1890. The translation module 1830 may operate in conjunction with the shadow generation modules 1840 to redraw shadows as their origin positions are modified.

In some embodiments, the blur module 1845 performs blurring operations on shadows. The blur module 1845 performs blurring operations in response to input to the blur control 1804. The blur module 1845 may operate in conjunction with the shadow generation modules 1840 to redraw shadows as their origin positions are modified.

In some embodiments, the rotation module 1895 adjusts the cast angles of shadows. The rotation module 1895 adjusts shadow cast angles in response to input to the rotational control 1808. The rotation module 1895 may operate in conjunction with the perspective module 1835 maintain shadow perspective effects while the cast angles of shadows are adjusted. The shadow perspective module 1835 adjusts shadow perspective effects in response to input to the perspective controls 1845.

While many of the features of the media-editing application 1800 have been described as being performed by one module (e.g., the UI interaction and generation module 1805, the media ingest module 1810, etc.), one of ordinary skill in the art will recognize that the functions described herein might be split up into multiple modules. Similarly, functions described as being performed by multiple different modules might be performed by a single module in some embodiments (e.g., the playback module 1825 might be part of the UI interaction and generation module 1805).

### VI. Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

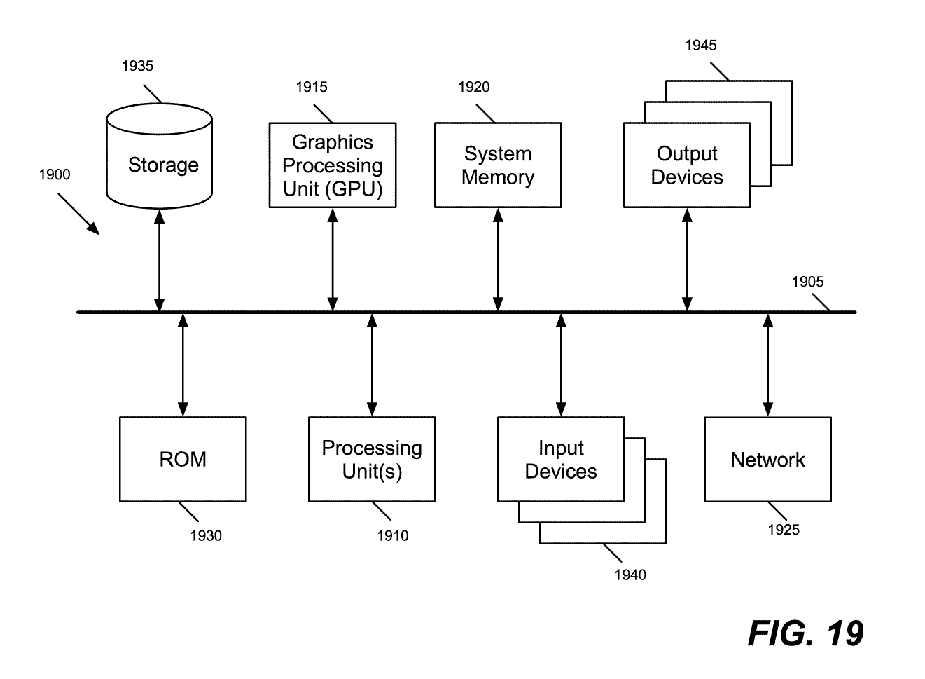

FIG. 19 conceptually illustrates another example of an electronic system 1900 with which some embodiments of the invention are implemented. The electronic system 1900 may be a computer (e.g., a desktop computer, personal computer, tablet computer, etc.), phone, PDA, or any other sort of electronic or computing device. Such an electronic system includes various types of computer readable media and interfaces for various other types of computer readable media. Electronic system 1900 includes a bus 1905, processing unit(s) 1910, a graphics processing unit (GPU) 1915, a system memory 1920, a network 1925, a read-only memory 1930, a permanent storage device 1935, input devices 1940, and output devices 1945.

The bus 1905 collectively represents all system, peripheral, and chipset buses that communicatively connect the numerous internal devices of the electronic system 1900. For instance, the bus 1905 communicatively connects the processing unit(s) 1910 with the read-only memory 1930, the GPU 1915, the system memory 1920, and the permanent storage device 1935.

From these various memory units, the processing unit(s) 1910 retrieves instructions to execute and data to process in order to execute the processes of the invention. The processing unit(s) may be a single processor or a multi-core processor in different embodiments. Some instructions are passed to and executed by the GPU 1915. The GPU 1915 can offload various computations or complement the image processing provided by the processing unit(s) 1910.

The read-only-memory (ROM) 1930 stores static data and instructions that are needed by the processing unit(s) 1910 and other modules of the electronic system. The permanent storage device 1935, on the other hand, is a read-and-write memory device. This device is a non-volatile memory unit that stores instructions and data even when the electronic system 1900 is off. Some embodiments of the invention use a mass-storage device (such as a magnetic or optical disk and its corresponding disk drive) as the permanent storage device 1935.

Other embodiments use a removable storage device (such as a floppy disk, flash memory device, etc., and its corresponding drive) as the permanent storage device. Like the permanent storage device 1935, the system memory 1920 is a read-and-write memory device. However, unlike storage device 1935, the system memory 1920 is a volatile read-and-write memory, such a random access memory. The system memory 1920 stores some of the instructions and data that the processor needs at runtime. In some embodiments, the invention's processes are stored in the system memory 1920, the permanent storage device 1935, and/or the read-only memory 1930. For example, the various memory units include instructions for processing multimedia clips in accordance with some embodiments. From these various memory units, the processing unit(s) 1910 retrieves instructions to execute and data to process in order to execute the processes of some embodiments.

The bus 1905 also connects to the input and output devices 1940 and 1945. The input devices 1940 enable the user to communicate information and select commands to the electronic system. The input devices 1940 include alphanumeric keyboards and pointing devices (also called “cursor control devices”), cameras (e.g., webcams), microphones or similar devices for receiving voice commands, etc. The output devices 1945 display images generated by the electronic system or otherwise output data. The output devices 1945 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 19, bus 1905 also couples electronic system 1900 to a network 1925 through a network adapter (not shown). In this manner, the computer can be a part of a network of computers (such as a local area network (“LAN”), a wide area network (“WAN”), or an Intranet, or a network of networks, such as the Internet. Any or all components of electronic system 1900 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the invention has been described with reference to numerous specific details, one of ordinary skill in the art will recognize that the invention can be embodied in other specific forms without departing from the spirit of the invention. For instance, many of the figures illustrate various touch gestures (e.g., taps, double taps, swipe gestures, press and hold gestures, etc.). However, many of the illustrated operations could be performed via different touch gestures (e.g., a swipe instead of a tap, etc) or by non-touch input (e.g., using a cursor controller, a keyboard, a touchpad/trackpad, a near-touch sensitive screen, etc.). In addition, FIG. 2 conceptually illustrates a process. The specific operations of this process may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

While the invention has been described with reference to numerous specific details, one of ordinary skill in the art will recognize that the invention can be embodied in other specific forms without departing from the spirit of the invention. For example, one of ordinary skill in the art will understand that many of the UI items of FIGS. 1, 3-10, and 12-17 can also be activated and/or set by a cursor control device (e.g., a mouse or trackball), a stylus, keyboard, a finger gesture (e.g., placing, pointing, tapping one or more fingers) near a near-touch sensitive screen, or any other control system in some embodiments. Thus, one of ordinary skill in the art would understand that the invention is not to be limited by the foregoing illustrative details, but rather is to be defined by the appended claims.

What is claimed is:

1. A method comprising:
providing a set of editing tools for producing a composite presentation from first and second media clips;
providing a preview display area for displaying a preview of the composite presentation; and
providing a shadow generation tool for generating a shadow for the second media clip and displaying the shadow in the preview display area, said shadow composited with the first and second media clips to produce the composite presentation, said shadow projection tool comprising a set of on-image controls for display in the preview display area near the second media clip, the set of on-image controls for modifying a set of attributes of the shadow based on user input.

2. The method of claim 1, wherein the set of attributes includes a blur attribute, wherein the set of on-image controls comprises a blur control for modifying the blur attribute.

3. The method of claim 2, wherein the blur control comprises a selectable item that when moved modifies the blur attribute.

4. The method of claim 2, wherein the set of attributes includes a blur falloff attribute that defines the extent to which the blurring of the shadow increases between the center of the shadow and the shadow's edges.

5. The method of claim 1, wherein the set of attributes includes a position value for an origin, wherein the set of on-image controls comprises a rotational control for rotating the shadow about the origin.

6. The method of claim 5, wherein a movement of the rotational control in a particular direction causes the base of the shadow to remain at the same location but changes the direction of the shadow towards that particular direction.

7. The method of claim 5, wherein the shadow is generated from an object in the second media clip, and is associated with a transition line, wherein a movement of the rotational control above the transition line causes the shadow to appear behind the object, and a movement of the rotational control below the transition line causes the shadow to appear in front of the object.

8. The method of claim 1, wherein the set of on-image controls comprises a translational control for moving the shadow.

9. The method of claim 1, wherein the set of on-image controls comprises a frame that bounds an area around the shadow.

10. The method of claim 1, wherein the set of attributes includes at least one of a color value for the shadow, an opacity value for the shadow, a blur value for the shadow, a blur falloff for the shadow, a perspective amount for the shadow, a position value for the shadow, and a perspective point position value for the shadow.

11. The method of claim 1 further comprising providing a shadow properties display area for displaying one or more attributes of the shadow.

12. The method of claim 11, wherein the shadow inspection panel comprises a set of selectable items for modifying the one or more attributes.

13. A non-transitory machine readable medium storing a program that when executed by a processing unit provides a user interface (UI), the UI comprising:
a set of editing tools for producing a composite presentation from first and second media clips;
a preview display area for displaying a preview of the composite presentation; and
a shadow generation tool for generating a shadow for the second media clip and displaying the shadow in the preview display area, said shadow composited with the first and second media clips to produce the composite presentation, said shadow projection tool comprising a set of on-image controls for display in the preview display area near the second media clip, the set of on-image controls for modifying a set of attributes of the shadow based on user input.

14. The non-transitory machine readable medium of claim 13, wherein the set of attributes includes a blur attribute, wherein the set of on-image controls comprises a blur control for modifying the blur attribute.

15. The non-transitory machine readable medium of claim 14, wherein the blur control comprises a selectable item that when moved modifies the blur attribute.

16. The non-transitory machine readable medium of claim 14, wherein the set of attributes includes a blur falloff attribute that defines the extent to which the blurring of the shadow increases between the center of the shadow and the shadow's edges.

17. A non-transitory machine readable storing a program for execution by at least one processing unit, the program comprising sets of instructions for:
receiving first and second media clips for compositing into a composite presentation;
generating a shadow with a set of attributes from the second media clip;
providing a display window for displaying a preview of the composite presentation, wherein the preview includes the first media clip, the second media clip, the generated shadow, and a set of on-image controls near the generated shadow; and
when the set of on-image controls receives user input, modifying the set of attributes of the shadow and the appearance of the generated shadow in accordance with the received user input.

18. The non-transitory machine readable medium of claim 17, wherein the set of attributes includes at least one of a color value for the shadow, an opacity value for the shadow, a blur value for the shadow, a blur falloff for the shadow, a perspective amount for the shadow, a position value for the shadow, and a perspective point position value for the shadow.

19. The non-transitory machine readable medium of claim 17, wherein the first media clip is a video clip.

20. The non-transitory machine readable medium of claim 17, wherein the second media clip is a still image with a transparent background.
